(19) United States
(12) Patent Application Publication
(10) Pub. No.: US 2024/0121744 A1
(43) Pub. Date: Apr. 11, 2024

(54) METHOD AND DEVICE FOR SUPPORTING COMMUNICATION BY USING SATELLITE IN WIRELESS COMMUNICATION SYSTEM

(71) Applicant: Samsung Electronics Co., Ltd., Suwon-si, Gyeonggi-do (KR)

(72) Inventor: Kyungjoo SUH, Suwon-si (KR)

(21) Appl. No.: 18/271,965

(22) PCT Filed: Jan. 14, 2022
(86) PCT No.: PCT/KR2022/000774

§ 371 Date: Jul. 12, 2023

(30) Foreign Application Priority Data
Jan. 15, 2021 (KR) 10-2021-0006370
Feb. 15, 2021 (KR) 10-2021-0020146
Feb. 18, 2021 (KR) 10-2021-0022203

(51) Int. Cl. H04W 60/04; H04W 48/16

(52) U.S. Cl. CPC H04W 60/04; H04W 48/16; H04W 84/042

(57) ABSTRACT

The disclosure provides a method of supporting communication by using a satellite in a wireless communication system including transmitting, by a user equipment (UE), a registration request message for accessing a public land mobile network (PLMN) to an access and mobility management function (AMF) through a satellite radio access network (RAN), receiving, by the UE, a registration reject message from the AMF through the satellite RAN in response to the transmitted registration request message, and storing the PLMN in a PLMN list not allowed in a current location of the UE based on a cause value included in the received registration reject message.

### TECHNICAL FIELD

The disclosure relates to a method and device for supporting communication by using a satellite in a wireless communication system. The disclosure also relates to a method and device for supporting security when a satellite is introduced to a wireless communication system. The disclosure also relates to a device and method for supporting emergency calls when a satellite is introduced to a wireless communication system.

### BACKGROUND ART

To meet the ever-increasing demand with respect to wireless data traffic since the commercialization of the fourth (4G) communication system, there have been efforts to develop an advanced fifth generation (5G) system or pre-5G communication system. For this reason, the 5G or pre-5G communication system is also called a beyond 4G network communication system or post long term evolution (LTE) system. The 5G communication system defined by the 3rd Generation Partnership Project (3GPP) is called a new radio (NR) system. Implementation of the 5G communication system using ultrahigh frequency (millimeter wave (mmWave)) bands, e.g., 60 giga hertz (GHz) bands, is being considered to attain higher data transfer rates. To reduce propagation loss of radio waves and increase a transmission range of radio waves in the ultra-frequency bands, beamforming, massive multiple-input multiple-output (MIMO), full dimensional MIMO (FD-MIMO), array antennas, analog beamforming, and large-scale antenna techniques are under discussion for the 5G communication system and are applied to an NR system. To improve system networks, technologies for advanced small cells, cloud radio access networks (RANs), ultra-dense networks, device to device (D2D) communication, wireless backhaul, moving networks, cooperative communication, coordinated multi-points (CoMP), reception-end interference cancellation and the like are also being developed in the 5G communication system. In addition, in the 5G system, an advanced coding modulation (ACM), e.g., hybrid FSK and QAM modulation (FQAM), sliding window superposition coding (SWSC), and an advanced access technology, e.g., filter bank multi carrier (FBMC), non-orthogonal multiple access (NOMA), and sparse code multiple access (SCMA) are being developed.

In the meantime, the Internet is evolving from a human-oriented connectivity network where humans generate and consume information to an Internet of things (IoT) network where distributed entities or things send, receive and process information without human intervention. Internet of Everything (IoE) technologies, in which a big data processing technology through connection with a cloud server, for example, are combined with an IoT technology, have also emerged. To implement IoT, various technologies, such as a sensing technology, a wired/wireless communication and network infrastructure, a service interfacing technology, and a security technology are required, and even technologies for sensor networks, machine to machine (M2M) communication, machine type communication (MTC) for connection between things are being studied these days. In the IoT environment, intelligent Internet technology (IT) services that create new values for human life by collecting and analyzing data generated from connected things may be provided. IoT may be applied to a variety of areas, such as smart home, smart buildings, smart cities, smart cars or connected cars, smart grid, health care, smart home appliances and advanced medical services through convergence and combination between existing information technologies (IT) and various industrial applications.

In this regard, various attempts to apply the 5G communication system to the IoT network are being made. For example, 5G communication such as a sensor network, M2M, MTC, etc., is implemented by such techniques as beamforming, MIMO, and array antenna, etc. Even application of a cloud radio access network (cloud RAN) as the aforementioned big data processing technology may be an example of convergence of 5G and IoT technologies.

As various services are becoming available with the advancement of mobile communication systems and the aforementioned technologies, a scheme for providing the services efficiently is required, and especially, a method of supporting communication in various environments or protecting user data is required.

### DISCLOSURE

### Technical Problem

Embodiments of the disclosure provide a method and device for supporting communication by using a satellite in a wireless communication system. Embodiments of the disclosure also provide a method and device for supporting security when a satellite is introduced to a wireless communication system. Embodiments of the disclosure also provide a method and device for supporting emergency calls when a satellite is introduced to a wireless communication system.

### Technical Solution

The disclosure provides a method of supporting communication by using a satellite in a wireless communication system including transmitting, by a user equipment (UE), a registration request message for accessing a public land mobile network (PLMN) to an access and mobility management function (AMF) through a satellite radio access network (RAN), receiving, by the UE, a registration reject message from the AMF through the satellite RAN in response to the transmitted registration request message, and storing the PLMN in a PLMN list not allowed in a current location of the UE based on a cause value included in the received registration reject message.

### Advantageous Effects

According to an embodiment of the disclosure, communication may be supported by using a satellite in a wireless communication system.

According to an embodiment of the disclosure, security may be supported when a satellite is introduced to a communication system.

According to an embodiment of the disclosure, emergency calls may be supported when a satellite is introduced to a communication system.

### DESCRIPTION OF DRAWINGS

FIG. 1A illustrates a first embodiment of a user equipment (UE) and network environment for supporting communication in a system supporting fifth generation (5G) wireless communication and a satellite, according to an embodiment of the disclosure.

FIG. 1B illustrates a second embodiment of a UE and network environment for supporting communication in a system supporting 5G wireless communication and a satellite, according to an embodiment of the disclosure.

FIG. 2 is a sequence chart for describing a procedure for supporting communication in a system that supports 5G wireless communication and a satellite, according to an embodiment of the disclosure.

FIG. 3 is a sequence chart for describing a procedure for supporting communication in a system that supports 5G wireless communication and a satellite, according to an embodiment of the disclosure.

FIG. 4 is a sequence chart for describing a procedure for supporting communication in a system that supports 5G wireless communication and a satellite, according to an embodiment of the disclosure.

FIG. 5 is a sequence chart for describing a procedure for supporting communication in a system that supports 5G wireless communication and a satellite, according to an embodiment of the disclosure.

FIG. 6 is a sequence chart for describing a procedure for supporting communication in a system that supports 5G wireless communication and a satellite, according to an embodiment of the disclosure.

FIG. 7 is a block diagram of a UE, according to an embodiment of the disclosure.

FIG. 8 is a block diagram of a network entity, according to an embodiment of the disclosure.

FIG. 9 is a sequence chart for describing a procedure for supporting communication in a system that supports 5G wireless communication and a satellite, according to an embodiment of the disclosure.

FIG. 10 is a sequence chart for describing a procedure for supporting communication in a system that supports 5G wireless communication and a satellite, according to an embodiment of the disclosure.

FIG. 11 is a sequence chart for describing a procedure for supporting communication in a system that supports 5G wireless communication and a satellite, according to an embodiment of the disclosure.

FIG. 12 is a sequence chart for describing a procedure for supporting communication in a system that supports 5G wireless communication and a satellite, according to an embodiment of the disclosure.

FIG. 13 is a sequence chart for describing a procedure for supporting communication in a system that supports 5G wireless communication and a satellite, according to an embodiment of the disclosure.

FIG. 14 is a sequence chart for describing a procedure for supporting communication in a system that supports 5G wireless communication and a satellite, according to an embodiment of the disclosure.

FIG. 15 is a sequence chart for describing a procedure for supporting communication in a system that supports 5G wireless communication and a satellite, according to an embodiment of the disclosure.

FIG. 16 is a sequence chart for describing a procedure for supporting communication in a system that supports 5G wireless communication and a satellite, according to an embodiment of the disclosure.

### BEST MODE

According to an embodiment of the disclosure, a user equipment (UE) for performing communication in a wireless communication system includes: a transceiver; and a processor connected to the transceiver, wherein the processor is configured to transmit, by the UE, a registration request message for accessing a public land mobile network (PLMN) to an access and mobility management function (AMF) through a satellite radio access network (RAN), receive, by the UE, a registration reject message from the AMF through the satellite RAN in response to the transmitted registration request message, and store the PLMN in a PLMN list not allowed in a current location of the UE based on a cause value included in the received registration reject message.

According to an embodiment of the disclosure, the UE for performing communication in a wireless communication system may not attempt to access at least one PLMN stored in the PLMN list not allowed in the current location of the UE.

According to an embodiment of the disclosure, in the UE for performing communication in a wireless communication system, the registration reject message may include information about a configuration of an extended timer.

According to an embodiment of the disclosure, in the UE for performing communication in a wireless communication system, the registration reject message may include information indicating a country where the UE is currently located.

According to an embodiment of the disclosure, an AMF for performing communication in a wireless communication system includes: a transceiver; and a processor connected to the transceiver, wherein the processor is configured to receive, from a UE, a registration request message for accessing a PLMN through a satellite RAN, and transmit a registration reject message to the UE through the satellite RAN in response to the transmitted registration request message when the PLMN is not allowed in a current location of the UE, wherein the registration reject message includes a cause value indicating that the PLMN is not allowed in the current location of the UE and the PLMN is stored in a PLMN list not allowed in the current location of the UE based on the cause value of the registration reject message.

According to an embodiment of the disclosure, a method by which a UE performs communication in a wireless communication system includes: transmitting, by the UE, a registration request message for accessing a PLMN to an AMF through a satellite RAN; receiving, by the UE, a registration reject message from the AMF through the satellite RAN in response to the transmitted registration request message; and storing the PLMN in a PLMN list not allowed in a current location of the UE based on a cause value included in the received registration reject message.

According to an embodiment of the disclosure, a method by which an AMF performs communication in a wireless communication system includes: receiving, from a UE, a registration request message for accessing a PLMN through a satellite RAN; and transmitting a registration reject message to the UE through the satellite RAN in response to the transmitted registration request message when the PLMN is not allowed in a current location of the UE, wherein the registration reject message includes a cause value indicating that the PLMN is not allowed in the current location of the UE and the PLMN is stored in a PLMN list not allowed in the current location of the UE based on the cause value of the registration reject message.

### MODE FOR INVENTION

Embodiments of the disclosure will be described in detail with reference to accompanying drawings. Technological content well-known in the art or not directly related to the disclosure is omitted in the following description. Through the omission of the content that might otherwise obscure the subject matter of the disclosure, the subject matter will be understood more clearly.

For the same reason, some parts in the accompanying drawings are exaggerated, omitted or schematically illustrated. The size of the respective elements may not fully reflect their actual size. Like numbers refer to like elements throughout the drawings.

Advantages and features of the disclosure, and methods for achieving them will be understood more clearly when the following embodiments are read with reference to the accompanying drawings. The embodiments of the disclosure may, however, be embodied in many different forms and should not be construed as limited to the embodiments set forth herein; rather, these embodiments of the disclosure are provided so that this disclosure will be thorough and complete, and will fully convey the scope of the embodiments of the disclosure to those of ordinary skill in the art. Like numbers refer to like elements throughout the specification.

It will be understood that each block and combination of the blocks of a flowchart may be performed by computer program instructions.

The computer program instructions may be loaded on a processor of a universal computer, a special-purpose computer, or other programmable data processing equipment, and thus they generate means for performing functions described in the block(s) of the flowcharts when executed by the processor of the computer or other programmable data processing equipment. The computer program instructions may also be stored in a computer-executable or computer-readable memory that may direct the computer or other programmable data processing apparatus to function in a particular manner, such that the instructions stored in the computer-executable or computer-readable memory may produce an article of manufacture including instruction means that perform the functions specified in the flowchart block(s). The computer program instructions may also be loaded onto the computer or other programmable data processing apparatus to cause a series of operational steps to be performed on the computer or other programmable apparatus to produce a computer implemented process such that the instructions that are executed on the computer or other programmable apparatus provide operations for implementing the functions specified in the flowchart block(s).

Furthermore, each block may represent a part of a module, segment, or code including one or more executable instructions to perform particular logic function(s). It is noted that the functions described in the blocks may occur out of order in some alternative embodiments. For example, two successive blocks may be performed substantially at the same time or in reverse order.

The term “module” (or sometimes “unit”) as used herein refers to a software or hardware component, such as field programmable gate array (FPGA) or application specific integrated circuit (ASIC), which performs some functions. However, the module is not limited to software or hardware. The module may be configured to be stored in an addressable storage medium, or to execute one or more processors. For example, the modules may include components, such as software components, object-oriented software components, class components and task components, processes, functions, attributes, procedures, subroutines, segments of program codes, drivers, firmware, microcodes, circuits, data, databases, data structures, tables, arrays, and variables. Functions served by components and modules may be combined into a smaller number of components and modules, or further divided into a larger number of components and modules. Moreover, the components and modules may be implemented to execute one or more central processing units (CPUs) in a device or security multimedia card. In embodiments, the module may include one or more processors.

Herein, the terms to identify access nodes, the terms to refer to network entities, the terms to refer to messages, the terms to refer to interfaces among network entities, the terms to refer to various types of identification information, etc., are examples for convenience of explanation. Accordingly, the disclosure is not limited to the terms as herein used, and may use different terms to refer to the items having the same meaning in a technological sense.

For convenience of explanation, the terms and names defined by the 3rd generation partnership project long term evolution (3GPP LTE) standard or their derivatives will be used hereinafter. The disclosure is not, however, limited to the terms and definitions, and may be equally applied to any systems that conform to other standards. In the disclosure, eNode B (eNB) may be interchangeably used with gNode B (gNB). For example, a base station referred to as an eNB may also indicate a gNB. The term ‘terminal’ or ‘user equipment (UE)’ may refer not only to a cell phone, a narrowband Internet of things (NB-IoT) device, and a sensor but also to various wireless communication devices.

Although embodiments of the disclosure will be primarily focused on communication standards defined by the third generation partnership project (3GPP), the subject matter of the disclosure may also be applicable to other communication systems with a similar technical background with minor changes without significantly departing from the scope of the disclosure, which may be possible under the determination of those of ordinary skill in the art to which the disclosure pertains.

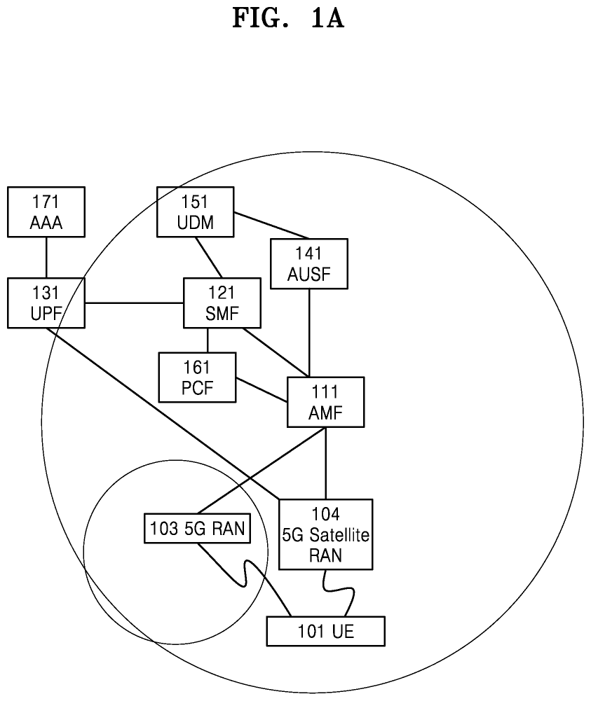

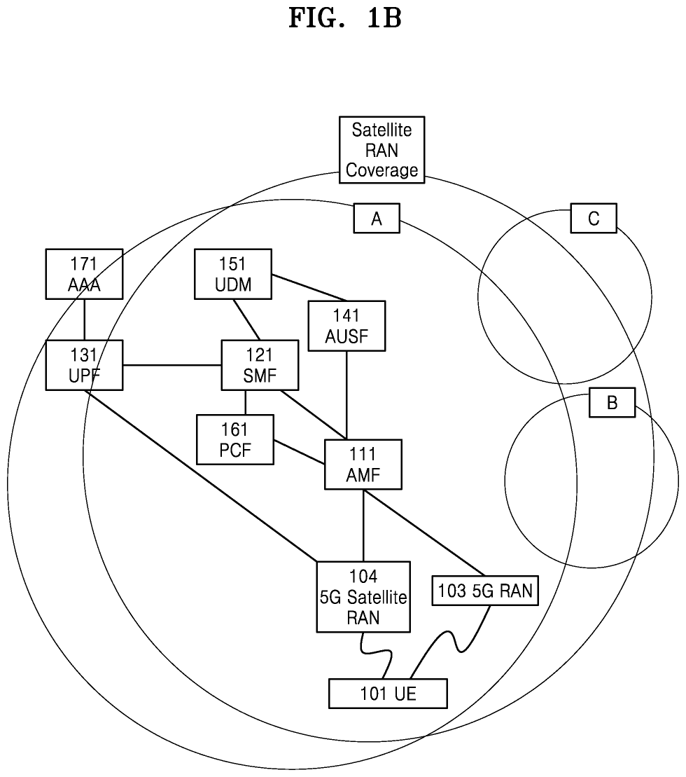

FIGS. 1A and 1B illustrate a first embodiment of a UE and network environment for supporting communication in a system supporting 5G wireless communication and a satellite, according to an embodiment of the disclosure.

Referring to FIG. 1A, a fifth generation (5G) or new radio (NR) core network may include network functions (NFs) such as a user plane function (UPF) 131, a session management function (SMF) 121, an access and mobility management function (AMF) 111, a 5G radio access network (RAN) 103, a user data management (UDM) 151, a policy control function (PCF) 161, and the like. Furthermore, to authenticate these entities, entities such as an authentication server function (AUSF) 141, an authentication, authorization and accounting (AAA) 171, etc., may be included.

A UE (or terminal) 101 may be connected to the 5G core network through a base station (BS) or 5G radio access network (RAN) 103. There may be an N3 interworking function (N3IWF) in case that the UE performs communication through non-3GPP access, in which case session management may be controlled by the UE, the non-3GPP access, the N3IWF, and the SMF and mobility management may be controlled by the UE, the non-3GPP access, the N3IWF, and the AMF.

In the 5G or NR system, entities for performing mobility management and session management are separated into the AMF 111 and the SMF 121. In the meantime, for the 5G or NR system, a standalone deployment structure that performs communication only with 5G or NR entities and a non-standalone deployment structure that uses both 4G entities and the 5G or NR entities are taken into account.

As shown in FIG. 1A, when the UE communicates with the network, it is possible to have deployment in the form in which an eNB is responsible for controlling and a 5G entity of a core network is used. In this case, mobility management between the UE and the AMF and session management between the UE and the SMF may be performed in a non access stratum (NAS) layer, which is layer 3.

In the meantime, access stratum (AS), layer 2, may be delivered between the UE and the eNB. Hence, there is a need for a scheme for creating and managing a security context when the UE 101 accesses the 5G RAN 103. In this regard, security context creation, management and protocol exchange that may be applied even to this deployment situation will be described in the disclosure.

Although the 5G or 4G LTE communication network is assumed as a communication network of the disclosure, this may be equally applied to other systems within the scope that may be understood by those of ordinary skill in the art.

Referring to FIGS. 1A and 1B, a BS 104 is a 5G satellite radio access network (RAN). The BS 104 may be a low earth orbit (LEO), medium earth orbit (MEO), geostationary orbit (GEO), or other satellite RAN. In the case of the satellite RAN, the LEO has an altitude of below 2,000 km, the MEO has an altitude of 8,000 km to 25,000 km, and the GEO has an altitude of 35,786 km.

When the satellite RAN is used, referring to FIG. 1B, an area covered by the satellite RAN is wider than an area covered by a normal BS. Specifically, an area covered by satellite NR is wider than an area covered by normal 5G-NR. As the satellite RAN covers wide area, the area covered by the satellite RAN may not be limited to a region of a country. For example, there are many neighboring countries, the area covered by the satellite RAN sometimes includes regions of different countries.

For example, referring to FIG. 1B, the satellite RAN 104 may cover regions A, B and C. As shown in FIG. 1B, the coverage of the satellite RAN 104 may sometimes extend over many regions and many countries.

In the meantime, the satellite NR may have an advantage of being constantly used in an environment where it is difficult to install a BS such as on the sea beyond the land or even when the BS is broken in a disastrous situation.

Furthermore, when the coverage of the BS extends over multiple countries, the BS may have a problem of which country's regulation, rule or law needs to be followed to perform communication. In addition, for the satellite NR, the fact that it may be more expensive than the normal 5G NR communication needs to be considered.

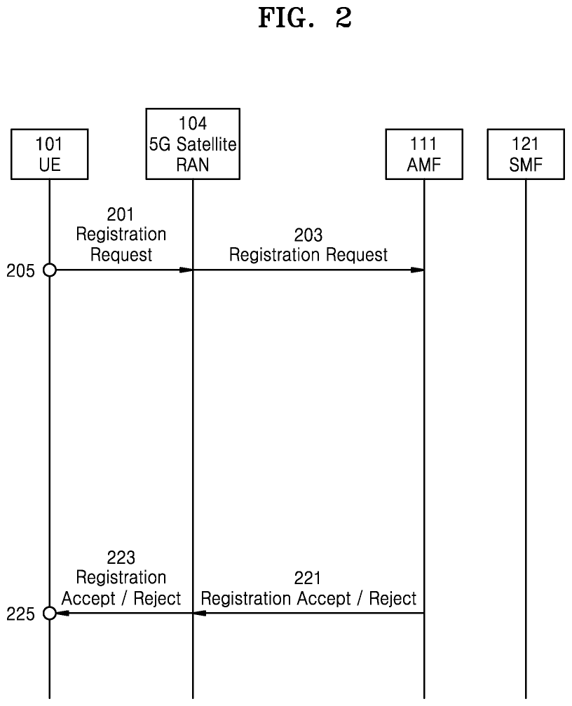

FIG. 2 is a sequence chart for describing a procedure for supporting communication in a system that supports 5G wireless communication and a satellite, according to an embodiment of the disclosure.

Referring to FIG. 2, an operation of the UE sending a registration request message to an AMF and a series of operations related to associated timers will be described.

What is shown in FIG. 2 is an embodiment of initial registration of a UE, which corresponds to an occasion when a timer value is set for the first time depending on the satellite radio access technology (RAT) type.

In operations 201, 203 and 205, the UE 101 registers itself by transmitting a registration request message to the AMF 111.

In operations 201 and 203, the UE 101 transmits the registration request message to the AMF 111. The registration request message is transmitted from the UE 101 to the AMF 111 through the 5G satellite RAN 104.

Referring to operations 201 and 203, the UE 101 notifies the AMF 111 of a capability of the UE 101 for the satellite RAN and an access RAT type indicating that it supports the satellite RAT type.
UE mobility management (MM) capability may include capability information about whether the UE supports the satellite RAN.
in another embodiment, the capability information indicating whether the UE supports the satellite RAN may be transmitted in an extra information element.
5G access type may include a 3GPP access type or a non-3GPP access type. Furthermore, for the 3GPP access type, the RAT type may include various RAT types such as NR (normal 5G NR), satellite (SAT) LEO (SAT-LEO), SAT-MEO, SAT-GEO, SAT-Other, etc.
hence, using both the access type information and the RAT type information or using single information about the RAT type, the UE may notify the AMF of what capability it has to support the satellite RAN.
in another embodiment, the UE may designate and indicate a RAT type wanted to be used by itself for registration. This may be a RAT type requested by the UE based on subscription of the UE.

Referring to operation 205, the UE 101 sets T3510 in operation 205 in a case that the UE 101 transmits a registration request message to the AMF 111 as in operations 201 and 203. The T3510 is a timer configured to be started when the UE 101 transmits the registration request message and stopped when the UE 101 receives a registration accept or a registration reject message.
in an embodiment, the T3510 may be configured as in the case of normal 5G NR.
in another embodiment, the T3510 may be an extended timer configured under the assumption of using the satellite NR.
in yet another embodiment, when the UE receives an extended timer value from the AMF, the UE may store the received extended time value and set the T3510 based on the stored extended timer value.
in still another embodiment, when the UE receives, from the AMF, an indication indicating that timer extension is possible, the UE may set the T3510 by multiplication. In an embodiment, in the case of LEO, MEO and GEO, when the UE receives the timer extension indication, the timer may be set by multiplying a default value of the timer by a timer extension enabled multiple.

In operations 221, 223 and 225, the AMF 111 sends a registration accept or registration reject message to the UE 101.

In operations 221 and 223, the AMF 111 transmits the registration accept or registration reject message to the UE 101. The registration accept or registration reject message is transmitted from the AMF 111 to the UE 101 through the 5G satellite RAN 104.

In the case of the registration accept message transmitted from the AMF 111 to the UE 101 in operations 221 and 223 in particular, it may include information about a RAT type accessible by the UE 101, an indication indicating whether timer extension of the UE is possible, extended priority, a timer extension value, etc.
the UE accessible RAT type (or UE access allowable RAT type information element) is an information element, i.e., a parameter, indicated by the AMF (network) to the UE. The UE accessible RAT type information is to notify the UE, by the AMF, of information about a RAT type allowed for the UE. The information notified by the AMF to the UE may include the following details: 1) an indication of a RAT type supported by the network, 2) a RAT type that may be served by the network for the UE among information of “RAT types (lists) that may be supported by the UE”, which is notified by the UE to the network through information about a capability of the UE, and 3) information about a supportable RAT type notified by the AMF to the UE based on subscription information of the UE.

Such information may be notified.
on receiving the information about a RAT type accessible by the UE, the UE may store the accessible RAT type information, and when transmitting a registration request message later on, use the information to perform registration. For registration, the UE may perform a function such as public land mobile network (PLMN) selection to select an accessible PLMN and a RAT type.
an indication indicating whether timer extension of the UE is possible is notified for the UE to set the timer as an extended timer for the satellite RAT.
RAT priority (extended priority) is to give priority to a UE accessible RAT based on subscription of the UE, rule/regulation of a region/country, regional property (sea or a region with no BS), etc., when the UE accessible RAT includes 5G NR, satellite NR, etc.
timer expansion value may be set by multiplying a default value of the timer by a timer extension value when the UE receives the timer extension value from the network in setting the timer for a message to be transmitted by the UE to the AMF. In an embodiment, in the case of LEO, MEO and LEO, the timer may be set by multiplying the default value of the timer by a timer extension enabled multiple.
timer extension fixed value is to set and indicate a value to set a timer according to a RAT type accessed by the UE in setting the timer for a message to be transmitted by the UE to the AMF. The timer extension fixed value may be transmitted according to a value defined in a regulation or specification depending on whether the RAT type of the satellite NR is LEO, MEO, GEO, or other RAT type.

In operation 225, when the UE 101 receives a registration accept or registration reject message from the AMF 111, the UE 101 stops the T3510.

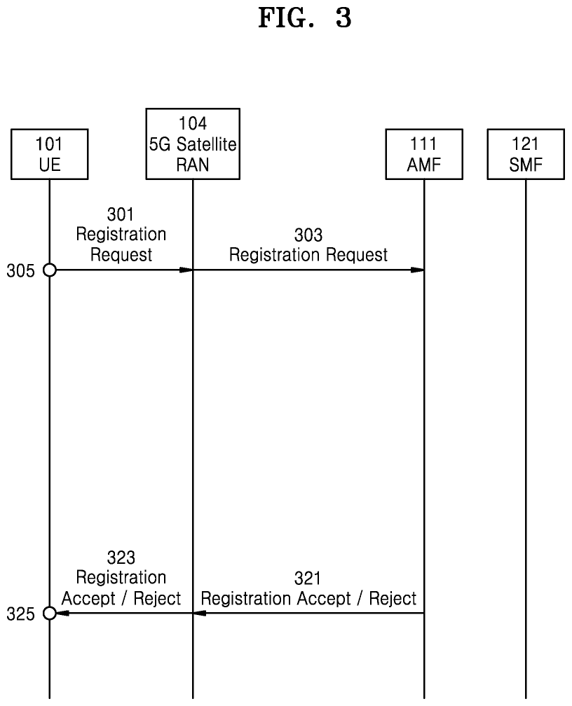

FIG. 3 is a sequence chart for describing a procedure for supporting communication in a system that supports 5G wireless communication and a satellite, according to an embodiment of the disclosure.

In FIG. 3, an operation of the UE sending a registration request message to an AMF and a series of operations related to associated timers are described.

FIG. 3 is an embodiment of a case that the UE 101 performs periodic registration, corresponding to a case of setting a timer value according to a satellite RAT type accessible by the UE 101 as the RAT accessible by the UE 101 may have been set.

In operations 301, 303 and 305, the UE 101 registers itself by transmitting a registration request message to the AMF 111.

In operations 301 and 303, the UE 101 transmits the registration request message to the AMF 111. The registration request message is transmitted from the UE 101 to the AMF 111 through the 5G satellite RAN 104.

Referring to operations 301 and 303, the UE 101 already completes registration through an initial registration procedure and thus has information about a RAT type accessible by the UE 101 in the corresponding region.

Accordingly, the UE 101 may transmit a registration request message with the accessible RAT type information.

Referring to operations 301 and 303, the UE 101 notifies the AMF 111 of a capability of the UE 101 for the satellite RAN and an access RAT type indicating that it supports the satellite RAT type.
UE MM capability may include capability information about whether the UE supports the satellite RAN.
in another embodiment, the capability information indicating whether the UE supports the satellite RAN may be transmitted in an extra information element.
5G access type may include a 3GPP access type or a non-3GPP access type. Furthermore, for the 3GPP access type, the RAT type may include various RAT types such as NR (normal 5G NR), SAT-LEO, SAT-MEO, SAT-GEO, SAT-Other, etc.
hence, using both the access type information and the RAT type information or using single information about the RAT type, the UE may notify the AMF of what capability it has to support the satellite RAN.
in another embodiment, the UE may designate and indicate a RAT type wanted to be used for registration. This may be a RAT type requested by the UE based on subscription of the UE.

FIG. 3 illustrates an occasion when the UE 101 transmits a periodic registration request message.

Referring to operation 305, the UE 101 already completes registration through an initial registration procedure and, performs periodic registration request.

In this case, the UE 101 has information about a RAT type accessible by the UE 101 in the corresponding region.

Accordingly, the UE 101 may transmit a registration request message with the accessible RAT type information.

Referring to operation 305, the UE 101 may determine whether the T3510 is to be set to extended T3510 or normal T3510 depending on the RAT type.

In another embodiment, instead of the extended T3510, the UE 101 may set T35xx which serves as the extended T3510 when the RAT type is a satellite RAN.

In yet another embodiment, the UE 101 may determine a value of the T3510 based on a RAT type supported in a tracking area (TA) recently visited by the UE 101 based on information about the TA based on a last visited tracking area identity (TAI).

Referring to operation 305, the UE 101 sets the T3510 in operation 305 in a case that the UE 101 transmits a registration request message to the AMF 111 as in operations 301 and 303. The T3510 is a timer configured to be started when the UE 101 transmits the registration request message and stopped when the UE 101 receives a registration accept or a registration reject message.
in an embodiment, the T3510 may be set as in normal 5G NR.
in another embodiment, the T3510 may be an extended timer configured under the assumption of using the satellite NR.
in yet another embodiment, when the UE receives an extended timer value from the AMF, the UE may store the received extended time value and set the T3510 based on the stored extended timer value.
in still another embodiment, when the UE receives, from the AMF, an indication indicating that timer extension is possible, the UE may set the T3510 by multiplication. In an embodiment, in the case of LEO, MEO and GEO, when the UE receives the timer extension indication, the timer may be set by multiplying a default value of the timer by a timer extension enabled multiple.

In operations 321, 323 and 325, the AMF 111 sends a registration accept or registration reject message to the UE 101.

In operations 321 and 323, the AMF 111 transmits the registration accept or registration reject message to the UE 101. The registration accept or registration reject message is transmitted from the AMF 111 to the UE 101 through the 5G satellite RAN 104.

The registration accept message transmitted from the AMF 111 to the UE 101 in operations 321 and 323 may include information about a RAT type accessible by the UE 101, an indication indicating whether timer extension of the UE 101 is possible, extended priority, a timer extension value, etc.
the UE accessible RAT type (or UE access allowable RAT type information element) is an information element, i.e., a parameter, indicated by the AMF (network) to the UE. The UE accessible RAT type information is to notify the UE, by the AMF, of information about a RAT type allowed for the UE. The information notified by the AMF to the UE may include the following details: 1) an indication of a RAT type supported by the network, 2) a RAT type that may be served by the network for the UE among information of “RAT types (lists) that may be supported by the UE”, which is notified by the UE to the network through information about a capability of the UE, and 3) information about a supportable RAT type notified by the AMF to the UE based on subscription information of the UE.

Such information may be notified.
on receiving the information about a RAT type accessible by the UE 101, the UE 101 may store the accessible RAT type information, and when transmitting a registration request message later on, use the information to perform registration. The UE 101 may perform a function such as PLMN selection by selecting an accessible PLMN and RAT type for registration.
an indication indicating whether timer extension of the UE is possible is notified for the UE to set the timer as an extended timer for the satellite RAT.
RAT priority (extended priority) is to give priority to a UE accessible RAT based on subscription of the UE, rule/regulation of a region/country, regional property (sea or a region with no BS), etc., when the UE accessible RAT includes 5G NR, satellite NR, etc.
timer expansion value may be set by multiplying a default value of the timer by a timer extension value when the UE receives the timer extension value from the network in setting the timer for a message to be transmitted by the UE to the AMF. In an embodiment, in the case of LEO, MEO and LEO, the timer may be set by multiplying the default value of the timer by a timer extension enabled multiple.
timer extension fixed value is to set and indicate a value to set a timer according to a RAT type accessed by the UE in setting the timer for a message to be transmitted by the UE to the AMF. The timer extension fixed value may be transmitted according to a value defined in a regulation or specification depending on whether the RAT type of the satellite NR is LEO, MEO, GEO, or other RAT type.

In operation 325, when the UE 101 receives a registration accept or registration reject message from the AMF 111, the UE 101 stops T3510.

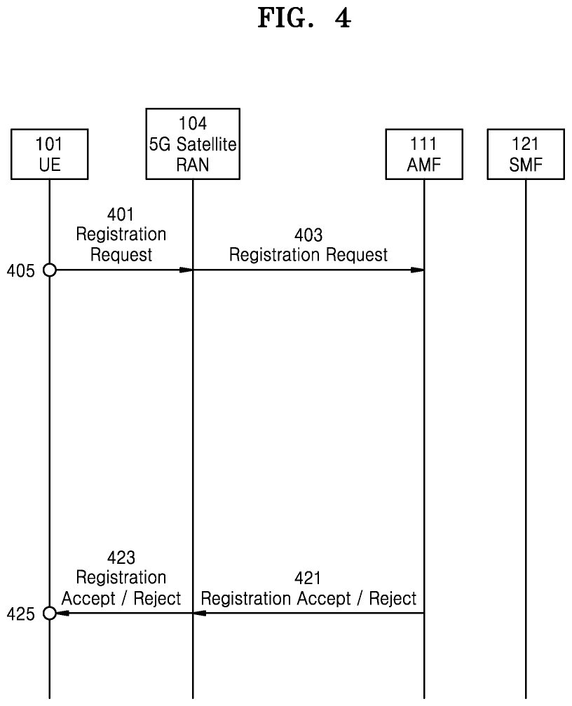

FIG. 4 is a sequence chart for describing a procedure for supporting communication in a system that supports 5G wireless communication and a satellite, according to an embodiment of the disclosure.

In FIG. 4, an operation of the UE sending a registration request message to an AMF and a series of operations related to associated timers are described.

FIG. 4 corresponds to an occasion when the UE 101 receives information about both the 5G NR and the satellite RAT as the accessible RAT. Accordingly, it corresponds to a case that the UE 101 may set both a value corresponding to the normal 5G NR and an extended timer value corresponding to the satellite RAT.

In operations 401, 403 and 405, the UE 101 registers itself by transmitting a registration request message to the AMF 111. In operations 401 and 403, the UE 101 transmits the registration request message to the AMF 111. The registration request message is transmitted from the UE 101 to the AMF 111 through the 5G satellite RAN 104.

Referring to operations 401 and 403, as the UE 101 already completed registration through the initial registration procedure, the UE has information about an accessible RAT type in the corresponding region.

Accordingly, the UE 101 may transmit a registration request message with the accessible RAT type information.

Referring to operations 401 and 403, the UE 101 notifies the AMF 111 of a capability of the UE 101 for the satellite RAN and an access RAT type indicating that it supports the satellite RAT type.
UE MM capability may include capability information about whether the UE supports the satellite RAN.
in another embodiment, the capability information indicating whether the UE supports the satellite RAN may be transmitted in an extra information element.
5G access type may include a 3GPP access type or a non-3GPP access type. Furthermore, for the 3GPP access type, the RAT type may include RAT types such as NR (normal 5G NR), SAT-LEO, SAT-MEO, SAT-GEO, SAT-Other, etc.
hence, using both the access type information and the RAT type information or using single information about the RAT type, the UE may notify the AMF of what capability it has to support the satellite RAN.
in another embodiment, the UE may designate and indicate a RAT type wanted to be used for registration. This may be a RAT type requested by the UE based on subscription of the UE.

FIG. 4 illustrates an occasion when the UE 101 transmits a periodic registration request message.

Referring to operation 405, UE 101 already completes registration through an initial registration procedure and, performs periodic registration request.

In this case, the UE 101 has information about a RAT type accessible by the UE 101 in the corresponding region.

Accordingly, the UE 101 may transmit a registration request message with the accessible RAT type information.

Referring to operation 405, the UE 101 may determine whether the T3510 is to be set to extended T3510 or normal T3510 depending on the RAT type.

In another embodiment, instead of the extended T3510, the UE 101 may set T35xx which serves as the extended T3510 when the RAT type is a satellite RAN.

In yet another embodiment, the UE 101 may determine a value of the T3510 based on a RAT type supported in a TA recently visited by the UE based on information about the TA based on a last visited TAI.

Referring to operation 405, the UE 101 sets the T3510 in operation 405 in a case that the UE 101 transmits a registration request message to the AMF 111 as in operations 401 and 403. The T3510 is a timer configured to be started when the UE 101 transmits the registration request message and stopped when the UE 101 receives a registration accept or a registration reject message.
in an embodiment, the T3510 may be set as in normal 5G NR.
in another embodiment, the T3510 may be an extended timer configured under the assumption of using the satellite NR.
in yet another embodiment, when the UE receives an extended timer value from the AMF, the UE may store the received extended time value and set the T3510 based on the stored extended timer value.
in still another embodiment, when the UE receives, from the AMF, an indication indicating that timer extension is possible, the UE may set the T3510 by multiplication. In an embodiment, in the case of LEO, MEO and GEO, when the UE receives the timer extension indication, the timer may be set by multiplying a default value of the timer by a timer extension enabled multiple.

In operations 421, 423 and 425, the AMF 111 sends a registration accept or registration reject message to the UE 101.

In operations 421 and 423, the AMF 111 transmits the registration accept or registration reject message to the UE 101. The registration accept or registration reject message is transmitted from the AMF 111 to the UE 101 through the 5G satellite RAN 104.

The registration accept message transmitted from the AMF 111 to the UE 101 in operations 421 and 423 may include information about a RAT type accessible by the UE 101, an indication indicating whether timer extension of the UE 101 is possible, extended priority, a timer extension value, etc.
the UE accessible RAT type (or UE access allowable RAT type information element) is an information element, i.e., a parameter, indicated by the AMF (network) to the UE. The UE accessible RAT type information is to notify the UE, by the AMF, of information about a RAT type allowed for the UE. The information notified by the AMF to the UE may include the following details: 1) an indication of a RAT type supported by the network, 2) a RAT type that may be served by the network for the UE among information of “RAT types (lists) that may be supported by the UE”, which is notified by the UE to the network through information about a capability of the UE, and 3) information about a supportable RAT type notified by the AMF to the UE based on subscription information of the UE.

Such information may be notified.
on receiving the information about a RAT type accessible by the UE, the UE may store the accessible RAT type information, and when transmitting a registration request message later on, use the information to perform registration. The UE 101 may perform a function such as PLMN selection by selecting an accessible PLMN and RAT type for registration.
an indication indicating whether timer extension of the UE is possible is notified for the UE to set the timer as an extended timer for the satellite RAT.
RAT priority (extended priority) is to give priority to a UE accessible RAT based on subscription of the UE, rule/regulation of a region/country, regional property (sea or a region with no BS), etc., when the UE accessible RAT includes 5G NR, satellite NR, etc.
timer expansion value may be set by multiplying a default value of the timer by a timer extension value when the UE receives the timer extension value from the network in setting the timer for a message to be transmitted by the UE to the AMF. In an embodiment, in the case of LEO, MEO and LEO, the timer may be set by multiplying the default value of the timer by a timer extension enabled multiple.
timer extension fixed value is to set and indicate a value to set a timer according to a RAT type accessed by the UE in setting the timer for a message to be transmitted by the UE to the AMF. The timer extension fixed value may be transmitted according to a value defined in a regulation or specification depending on whether the RAT type of the satellite NR is LEO, MEO, GEO, or other RAT type.

In operation 425, when the UE 101 receives a registration accept or registration reject message from the AMF 111, the UE 101 stops the T3510.

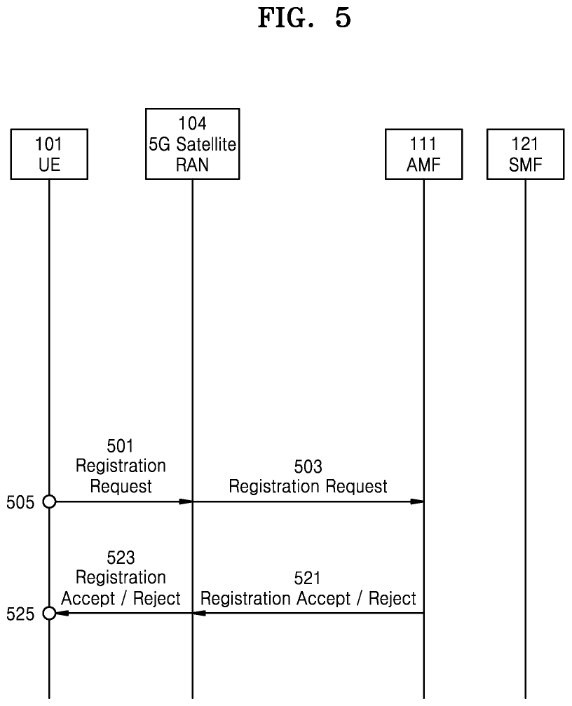

FIG. 5 is a sequence chart for describing a procedure for supporting communication in a system that supports 5G wireless communication and a satellite, according to an embodiment of the disclosure.

In FIG. 5, an operation of the UE sending a registration request message to an AMF and a series of operations related to associated timers are described.

FIG. 5 corresponds to an occasion when the UE 101 receives information about both the 5G NR and the satellite RAT as the accessible RAT. Accordingly, it corresponds to a case that the UE 101 may set both a value corresponding to the normal 5G NR and an extended timer value corresponding to the satellite RAT.

Furthermore, it corresponds to a case that the timer is differently set and used even for the same operation for the 5G NR and the satellite RAT.

In an embodiment, after sending a registration request, the UE 101 sets the T3510 for the 5G NR. On the other hand, when the UE 101 is able to access a RAT type corresponding to the satellite RAT, the UE 101 may send a registration request message and set an extended timer, i.e., T35xx.

In another embodiment, the same timer may be used with a different timer value. After sending a registration request, the UE 101 sets the T3510 for the 5G NR. In the meantime, when the UE 101 may access the RAT type corresponding to the satellite RAT, the UE 101 may send a registration request message and set the T3510 to have an extended timer value, e.g., a value obtained by multiplying a value set to the extended timer value or a default timer value by a multiple.

In operations 501, 503 and 505, the UE 101 registers itself by transmitting a registration request message to the AMF 111.

In operations 501 and 503, the UE 101 transmits the registration request message to the AMF 111. The registration request message is transmitted from the UE 101 to the AMF 111 through the 5G satellite RAN 104.

Referring to operations 501 and 503, the UE 101 already completes registration through an initial registration procedure, and has information about a RAT type accessible by the UE in the corresponding region.

Accordingly, the UE 101 may transmit a registration request message with the accessible RAT type information.

Referring to operations 501 and 503, the UE 101 notifies the AMF 111 of a capability of the UE 101 for the satellite RAN and an access RAT type indicating that it supports the satellite RAT type.
UE MM capability may include capability information about whether the UE supports the satellite RAN.
in another embodiment, the capability information indicating whether the UE supports the satellite RAN may be transmitted in an extra information element.
5G access type may include a 3GPP access type or a non-3GPP access type. Furthermore, for the 3GPP access type, the RAT type may include RAT types such as NR (normal 5G NR), SAT-LEO, SAT-MEO, SAT-GEO, SAT-Other, etc.
hence, using both the access type information and the RAT type information or using single information about the RAT type, the UE may notify the AMF of what capability it has to support the satellite RAN.
in another embodiment, the UE may designate and indicate a RAT type wanted to be used for registration. This may be a RAT type requested by the UE based on subscription of the UE.

FIG. 5 illustrates an occasion when the UE 101 transmits a periodic registration request message.

Referring to operation 505, the UE 101 already completes registration through an initial registration procedure, and performs a periodic registration request.

In this case, the UE 101 has information about a RAT type accessible by the UE 101 in the corresponding region.

Accordingly, the UE 101 may transmit a registration request message with the accessible RAT type information.

Referring to operation 505, the UE 101 may determine whether the T3510 is to be set to extended T3510 or normal T3510 depending on the RAT type.

In another embodiment, instead of the extended T3510, the UE 101 may set T35xx which serves as the extended T3510 when the RAT type is a satellite RAN.

In yet another embodiment, the UE 101 may determine a value of the T3510 based on a RAT type supported in a TA recently visited by the UE based on information about the TA based on a last visited TAI.

Referring to operation 505, the UE 101 sets the T3510 in operation 505 in a case that the UE transmits a registration request message to the AMF as in operations 501 and 503. The T3510 is a timer configured to be started when the UE 101 transmits the registration request message and stopped when the UE 101 receives a registration accept or a registration reject message.
in an embodiment, the T3510 may be set as in normal 5G NR.
in another embodiment, the T3510 may be an extended timer configured under the assumption of using the satellite NR.
in yet another embodiment, when the UE receives an extended timer value from the AMF, the UE may store the received extended time value and set the T3510 based on the stored extended timer value.
in still another embodiment, when the UE receives, from the AMF, an indication indicating that timer extension is possible, the UE may set the T3510 by multiplication. In an embodiment, in the case of LEO, MEO and GEO, when the UE receives the timer extension indication, the timer may be set by multiplying a default value of the timer by a timer extension enabled multiple.

In operations 521, 523 and 525, the AMF 111 sends a registration accept or registration reject message to the UE 101.

In operations 521 and 523, the AMF 111 transmits the registration accept or registration reject message to the UE 101. The registration accept or registration reject message is transmitted from the AMF 111 to the UE 101 through the 5G satellite RAN 104.

The registration accept message transmitted from the AMF 111 to the UE 101 in operations 521 and 523 may include information about a RAT type accessible by the UE 101, an indication indicating whether timer extension of the UE 101 is possible, extended priority, a timer extension value, etc.
the UE accessible RAT type (or UE access allowable RAT type information element) is an information element, i.e., a parameter, indicated by the AMF (network) to the UE. The UE accessible RAT type information is to notify the UE, by the AMF, of information about a RAT type allowed for the UE. The information notified by the AMF to the UE may include the following details: 1) an indication of a RAT type supported by the network, 2) a RAT type that may be served by the network for the UE among information of “RAT types (lists) that may be supported by the UE”, which is notified by the UE to the network through information about a capability of the UE, and 3) information about a supportable RAT type notified by the AMF to the UE based on subscription information of the UE.

Such information may be notified.
on receiving the information about a RAT type accessible by the UE, the UE may store the accessible RAT type information, and when transmitting a registration request message later on, use the information to perform registration. The UE may perform a function such as PLMN selection by selecting an accessible PLMN and RAT type for registration.
an indication indicating whether timer extension of the UE is possible is notified for the UE to set the timer as an extended timer for the satellite RAT.
RAT priority (extended priority) is to give priority to a UE accessible RAT based on subscription of the UE, rule/regulation of a region/country, regional property (sea or a region with no BS), etc., when the UE accessible RAT includes 5G NR, satellite NR, etc.
timer expansion value may be set by multiplying a default value of the timer by a timer extension value when the UE receives the timer extension value from the network in setting the timer for a message to be transmitted by the UE to the AMF. In an embodiment, in the case of LEO, MEO and LEO, the timer may be set by multiplying the default value of the timer by a timer extension enabled multiple.
timer extension fixed value is to set and indicate a value to set a timer according to a RAT type accessed by the UE in setting the timer for a message to be transmitted by the UE to the AMF. The timer extension fixed value may be transmitted according to a value defined in a regulation or specification depending on whether the RAT type of the satellite NR is LEO, MEO, GEO, or other RAT type.

As shown in operation 525, when the UE 101 receives a registration accept or registration reject message from the AMF 111, the UE 101 stops the T3510.

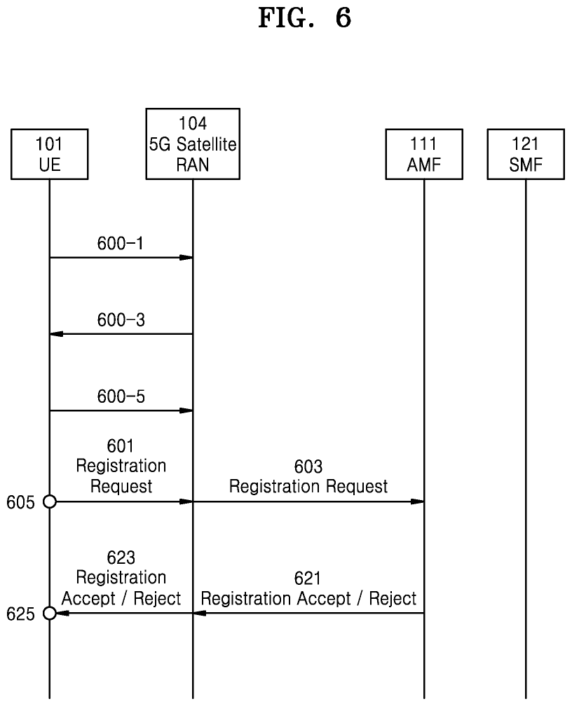

FIG. 6 is a sequence chart for describing a procedure for supporting communication in a system that supports 5G wireless communication and a satellite, according to an embodiment of the disclosure.

In FIG. 6, an operation of the UE sending a registration request message to an AMF and a series of operations related to associated timers are described.

FIG. 6 corresponds to an occasion when the UE 101 receives information about both the 5G NR and the satellite RAT as the accessible RAT. Accordingly, it corresponds to a case that the UE 101 sets a timer value with the help of NR, i.e., the BS, when the UE is able to set both a value corresponding to the normal 5G NR and an extended timer value corresponding to the satellite RAT.

In this case, the UE 101 receives an extended timer value in a radio resource control (RRC) complete message of RRC messages with the help of the access stratum (AS) layer, i.e., a message sent from the BS 104 to the UE 101, as in operations 600-1, 600-3 and 600-5. The UE 101 then forwards the received extended timer value from the AS layer to a non-access stratum (NAS) layer to use the timer value.

In an embodiment, in operation 600-1, the UE 101 sends an RRC setup message to the 5G satellite RAN 104, and in operation 600-3, the UE 101 receives an RRC response message. As in operation 600-5, when a cell to be camped on is determined while the UE 101 sends the RRC complete message to the 5G satellite RAN 104, the UE 101 may transmit the registration request message of operation 601 while sending the RRC complete message.

In another embodiment, the UE 101 may calculate an NAS timer value to be used in the NAS layer based on a T timer value used in the AS layer. In other words, there may be a method by which the UE 101 calculates an NAS timer value by multiplying the T timer value used in the AS layer and sends the NAS timer value to the NAS layer from the AS layer. In yet another embodiment, the UE 101 sends the T timer value from the AS layer to the NAS layer so that the NAS layer may set and use a timer value of the NAS layer based on the value of the AS layer.

In operations 601, 603 and 605, the UE 101 registers itself by transmitting a registration request message to the AMF 111.

In operations 601 and 603, the UE 101 transmits the registration request message to the AMF 111. The registration request message is transmitted from the UE 101 to the AMF 111 through the 5G satellite RAN 104.

Referring to operations 601 and 603, as the UE 101 already completed registration through the initial registration procedure, the UE has information about an accessible RAT type in the corresponding region.

Accordingly, the UE 101 may transmit a registration request message with the accessible RAT type information.

Referring to operations 601 and 603, the UE 101 notifies the AMF 111 of a capability of the UE 101 for the satellite RAN and an access RAT type indicating that it supports the satellite RAT type.
UE MM capability may include capability information about whether the UE supports the satellite RAN. The information may be notified by using an indication, Satellite RATCapable.
in another embodiment, the capability information indicating whether the UE supports the satellite RAN may be transmitted in an extra information element. The information may be notified by using an indication Satellite RATCapable.
5G access type may include a 3GPP access type or a non-3GPP access type. Furthermore, for the 3GPP access type, the RAT type may include RAT types such as NR (normal 5G NR), SAT-LEO, SAT-MEO, SAT-GEO, SAT-Other, etc.
hence, using both the access type information and the RAT type information or using single information about the RAT type, the UE may notify the AMF of what capability it has to support the satellite RAN.
in another embodiment, the UE may designate and indicate a RAT type wanted to be used for registration. This may be a RAT type requested by the UE based on subscription of the UE.

TABLE 1
registration request message

| IEI | Information Element | Type/Reference | Presence | Format | Length |
|---|---|---|---|---|---|
| | Extended protocol | Extended Protocol | M | V | 1 |
| | discriminator | discriminator | | | |
| | Security header type | Security header type | M | V | ½ |
| | Spare half octet | Spare half octet | M | V | ½ |
| | Registration request | Message type | M | V | 1 |
| | message identity | | | | |
| | 5GS registration type | 5GS registration type | M | V | ½ |
| | ngKSI | NAS key set identifier | M | V | ½ |
| | 5GS mobile identity | 5GS mobile identity | M | LV-E | 6-n |
| C- | Non-current native NAS | NAS key set identifier | O | TV | 1 |
| | key set identifier | | | | |
| 10 | 5GMM capability | 5GMM capability | O | TLV | 3-15 |
| 2E | UE security capability | UE security capability | O | TLV | 4-10 |
| 2F | Requested NSSAI | NSSAI | O | TLV | 4-74 |
| 52 | Last visited registered | 5GS tracking area identity | O | TV | 7 |
| | TAI | | | | |
| 6A | T3324 value | GPRS timer 3 | O | TLV | 3 |
| | RAT type | | | | |
| | Access Type | | | | |
| | Satelite RAT Capable | | | | |

TABLE 2
5GMM capability

| 8 | 7 | 6 | 5 | 4 | 3 | 2 | 1 | |
|---|---|---|---|---|---|---|---|---|
| 5GMM capability IEI | | | | | | | | octet 1 |
| Length of 5GMM capability contents | | | | | | | | octet 2 |
| SGC | 5G- | N3 | 5G-CPCIoT | RestrictEC | LPP | HO | S1 | octet 3 |
| | IPHC- | data | | | | attach | mode | |
| | CPCIoT | | | | | | | |
| RACS | NSSAA | 5G- | V2XCNPC5 | V2XCEPC5 | V2X | 5G- | 5GSRVCC | octet 4* |
| | | LCS | | | | UPCIoT | | |
| 0 | 0 | Satelite | ER- | 5G- | multipleUP | WUSA | CAG | |
| | | RAT | NSSAI | EHC- | | | | |
| | | Capable | | CPCIoT | | | | |
| 0 | 0 | 0 | 0 | 0 | 0 | 0 | 0 | octet 6*-15* |

Spare

FIG. 6 illustrates an occasion when the UE 101 transmits a periodic registration request message.

Referring to operation 605, the UE 101 already completes registration through an initial registration procedure, and performs periodic registration request.

Alternatively, the UE 101 may perform registration through an initial registration procedure.

In this case, the UE 101 has information about a RAT type accessible by the UE 101 in the corresponding region.

Accordingly, the UE 101 may transmit a registration request message with the accessible RAT type information.

Referring to operation 605, the UE 101 may determine whether the T3510 is to be set to extended T3510 or normal T3510 depending on the RAT type.

In another embodiment, instead of the extended T3510, the UE 101 may set T35xx which serves as the extended T3510 when the RAT type is a satellite RAN.

In yet another embodiment, the UE 101 may determine a value of the T3510 based on a RAT type supported in a TA recently visited by the UE based on information about the TA based on a last visited TAI.

Referring to operation 605, the UE 101 sets the T3510 in operation 605 in a case that the UE transmits a registration request message to the AMF as in operations 601 and 603. The T3510 is a timer configured to be started when the UE 101 transmits the registration request message and stopped when the UE 101 receives a registration accept or a registration reject message.
in an embodiment, the T3510 may be configured as in the case of normal 5G NR.
in another embodiment, the T3510 may be an extended timer configured under the assumption of using the satellite NR.
in yet another embodiment, when the UE receives an extended timer value from the AMF, the UE may store the received extended time value and set the T3510 based on the stored extended timer value.
in still another embodiment, when the UE receives, from the AMF, an indication indicating that timer extension is possible, the UE may set the T3510 by multiplication. In an embodiment, in the case of LEO, MEO and GEO, when the UE receives the timer extension indication, the timer may be set by multiplying a default value of the timer by a timer extension enabled multiple.

In operations 621, 623 and 625, the AMF 111 sends a registration accept or registration reject message to the UE 101.

In operations 621 and 623, the AMF 111 transmits the registration accept or registration reject message to the UE 101. The registration accept or registration reject message is transmitted from the AMF 111 to the UE 101 through the 5G satellite RAN 104.

The registration accept message transmitted from the AMF 111 to the UE 101 in operations 621 and 623 may include information about a RAT type accessible by the UE 101, an indication indicating whether timer extension of the UE 101 is possible, extended priority, a timer extension value, etc.

TABLE 3
registration accept message

| IEI | Information Element | Type/Reference | Presence | Format | Length |
|---|---|---|---|---|---|
| | Extended protocol | Extended protocol | M | V | 1 |
| | discriminator | discriminator | | | |
| | Security header type | Security header type | M | V | ½ |
| | Spare half octet | Spare half octet | M | V | ½ |
| | Registration accept | Message type | M | V | 1 |
| | message identity | | | | |
| | 5GS registration result | 5GS registration result | M | LV | 2 |
| 77 | 5G-GUTI | 5GS mobile identity | O | TLV-E | 14 |
| 4A | Equivalent PLMNs | PLMN list | O | TLV | 5-47 |
| 54 | TAI list | 5GS tracking area identity | O | TLV | 9-114 |
| | | list | | | |
| 21 | 5GS network feature support | 5GS network feature support | O | TLV | 3-5 |
| B- | MICO indication | MICO indication | O | TV | 1 |
| 9- | Network slicing indication | Network slicing indication | O | TV | 1 |
| 27 | Service area list | Service area list | O | TLV | 6-114 |
| 5D | Non-3GPP de-registration | GPRS timer 2 | O | TLV | 3 |
| | timer value | | | | |
| 67 | UE radio capability ID | UE radio capability ID | O | TLV | 3-n |
| E- | UE radio capability ID | UE radio capability ID | O | TV | 1 |
| | detection indication | detection indication | | | |
| | UE accessible RAT type | | | | |
| | Indication indicating | | | | |
| | whether timer extension | | | | |
| | of UE is possible | | | | |
| | RAT priority | | | | |
| | Extended T3510 value | | | | |
| | Timer extension value | | | | |
| | T3510 value | | | | |
| | New Timer T35xx value | | | | |

the UE accessible RAT type (or UE access allowable RAT type information element) is an information element, i.e., a parameter, indicated by the AMF (network) to the UE. The UE accessible RAT type information is to notify the UE, by the AMF, of information about a RAT type allowed for the UE. The information notified by the AMF to the UE may include the following details: 1) an indication of a RAT type supported by the network, 2) a RAT type that may be served by the network for the UE among information of “RAT types (lists) that may be supported by the UE”, which is notified by the UE to the network through information about a capability of the UE, and 3) information about a supportable RAT type notified by the AMF to the UE based on subscription information of the UE.

Such information may be notified.
on receiving the information about a RAT type accessible by the UE, the UE may store the accessible RAT type information, and when transmitting a registration request message later on, use the information to perform registration. The UE may perform a function such as PLMN selection by selecting an accessible PLMN and RAT type for registration.
an indication indicating whether timer extension of the UE is possible is notified for the UE to set the timer as an extended timer for the satellite RAT.
RAT priority (extended priority) is to give priority to a UE accessible RAT based on subscription of the UE, rule/regulation of a region/country, regional property (sea or a region with no BS), etc., when the UE accessible RAT includes 5G NR, satellite NR, etc.
timer expansion value may be set by multiplying a default value of the timer by a timer extension value when the UE receives the timer extension value from the network in setting the timer for a message to be transmitted by the UE to the AMF. In an embodiment, in the case of LEO, MEO and LEO, the timer may be set by multiplying the default value of the timer by a timer extension enabled multiple.
timer extension fixed value is to set and indicate a value to set a timer according to a RAT type accessed by the UE in setting the timer for a message to be transmitted by the UE to the AMF. The timer extension fixed value may be transmitted according to a value defined in a regulation or specification depending on whether the RAT type of the satellite NR is LEO, MEO, GEO, or other RAT type.
the timer extension fixed value may be transmitted in an information element of an extended T3510 value, a T3510 value or a new timer T35xx value. The extended T3510 value may be transmitted as a value determined according to the satellite, when the RAT is the satellite, transmitted by using a GPRS timer, a GPRS timer 2, GPRS timer 3, etc., transmitted as a multiple of the GPRS timer, the GPRS timer 2, or the GPRS timer 3, or transmitted in the form of a satellite timer by defining the satellite timer. Alternatively, for the T3510, when a RAT type is a normal 5G RAN for a RAT on which the UE camps, i.e., a RAT known by the AMF as the RAT on which the UE camps, a T3510 default value may be transmitted, and when the RAT type is a satellite RAT, an extended T3510 value may be transmitted.

As shown in operation 625, when the UE 101 receives a registration accept or registration reject message from the AMF 111, the UE 101 stops the T3510.

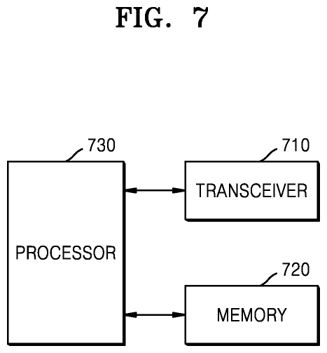

FIG. 7 is a block diagram of a UE, according to an embodiment of the disclosure.

Referring to FIG. 7, the UE in the disclosure may include a transceiver 710, a memory 720, and a processor 730. The transceiver 710, the memory 720, and the processor 730 of the UE may operate according to the aforementioned communication method of the UE. Components of the UE are not, however, limited thereto. For example, the UE may include more or fewer elements than described above. In addition, the processor 730, the transceiver 710, and the memory 720 may be implemented in a single chip.

The transceiver 710 is a collective term of a UE transmitter and a UE receiver, and may transmit or receive a signal to or from a network entity. The signal to be transmitted to or received from the BS may include control information and data. For this, the transceiver 710 may include an RF transmitter for up-converting the frequency of a signal to be transmitted and amplifying the signal and an RF receiver for low-noise amplifying a received signal and down-converting the frequency of the received signal. It is merely an example of the transceiver 710, and the elements of the transceiver 710 are not limited to the RF transmitter and RF receiver.

The transceiver 710 may include a wired/wireless transceiver, including various components for signal transmission and reception.

In addition, the transceiver 710 may receive a signal on a wireless channel and output the signal to the processor 730, and transmit a signal output from the processor 730 on a wireless channel.

The transceiver 710 may receive a communication signal and output the communication signal to the processor 730, and transmit a signal output from the processor 730 to a network entity over a wired or wireless network.

The memory 720 may store a program and data required for operation of the UE. Furthermore, the memory 720 may store control information or data included in a signal obtained by the UE. The memory 720 may include a storage medium such as a read only memory (ROM), a random access memory (RAM), a hard disk, a compact disc ROM (CD-ROM), and a digital versatile disk (DVD), or a combination thereof.

The processor 730 may control a series of processes for the UE to be operated according to the embodiments of the disclosure. The processor 730 may include at least one processor. For example, the processor 730 may include a communication processor (CP) for controlling communication and an application processor (AP) for controlling a higher layer such as an application program.

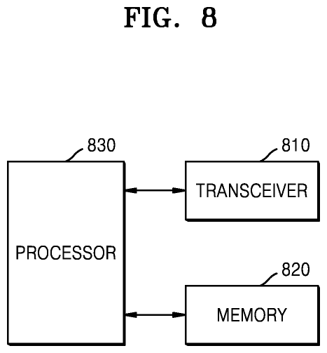

FIG. 8 is a block diagram of a network entity, according to an embodiment of the disclosure.

Referring to FIG. 8, the network entity in the disclosure may include a transceiver 810, a memory 820, and a processor 830. The transceiver 810, the memory 820, and the processor 830 of the network entity may operate according to the aforementioned communication method of the network entity. Components of the network entity are not, however, limited thereto. For example, the network entity may include more or fewer elements than described above. In addition, the processor 830, the transceiver 810, and the memory 820 may be implemented in a single chip. The network entity may include network functions (NFs) such as an AMF, an SMF, a PCF, a NEF, a UDM, a UPF, etc., as described above. Furthermore, the network entity may include a base station.

The transceiver 810 is a collective term of a network entity transmitter and a network entity receiver, and may transmit or receive a signal to or from a UE or another network entity. The signal to be transmitted to or received may include control information and data. For this, the transceiver 810 may include an RF transmitter for up-converting the frequency of a signal to be transmitted and amplifying the signal and an RF receiver for low-noise amplifying a received signal and down-converting the frequency of the received signal. It is merely an example of the transceiver 810, and the elements of the transceiver 810 are not limited to the RF transmitter and RF receiver. The transceiver 810 may include a wired/wireless transceiver, including various components for signal transmission and reception.

In addition, the transceiver 810 may receive a signal on a communication channel (e.g., a wireless channel) and output the signal to the processor 830, or transmit a signal output from the processor 830 on the communication channel.

The transceiver 810 may receive a communication signal and output the communication signal to the processor 830, and transmit a signal output from the processor 830 to a UE or a network entity over a wired or wireless network.

The memory 820 may store a program and data required for an operation of the network entity. Furthermore, the memory 820 may store control information or data included in a signal obtained by the network entity. The memory 820 may include a storage medium such as a ROM, a RAM, a hard disk, a CD-ROM, and a DVD, or a combination of storage mediums.

The processor 830 may control a series of processes for the network entity to be operated according to the embodiments of the disclosure. The processor 830 may include at least one processor. Methods according to the claims of the disclosure or the embodiments of the disclosure described in the specification may be implemented in hardware, software, or a combination of hardware and software.

When implemented in software, a computer-readable storage medium storing one or more programs (software modules) may be provided. The one or more programs stored in the computer-readable storage medium are configured for execution by one or more processors in an electronic device. The one or more programs may include instructions that cause the electronic device to perform the methods in accordance with the claims of the disclosure or the embodiments described in the specification.

The programs (software modules, software) may be stored in a RAM, a non-volatile memory including a flash memory, a ROM, an electrically erasable programmable ROM (EEPROM), a magnetic disc storage device, a CD-ROM, a DVD or other types of optical storage device, and/or a magnetic cassette. Alternatively, the programs may be stored in a memory including a combination of some or all of them. There may be a plurality of memories.

The program may also be stored in an attachable storage device that may be accessed over a communication network including the Internet, an intranet, a local area network (LAN), a wide LAN (WLAN), or a storage area network (SAN), or a combination thereof. The storage device may be connected to an apparatus performing the embodiments of the disclosure through an external port. In addition, a separate storage device in the communication network may be connected to the apparatus performing the embodiments of the disclosure.

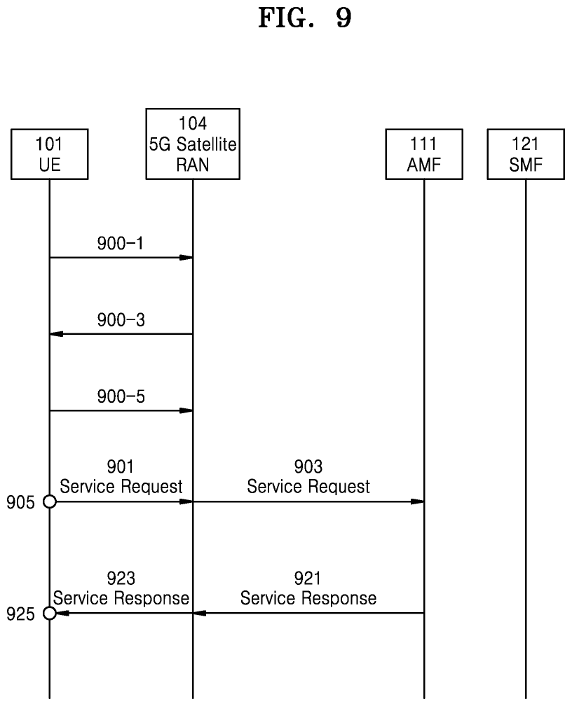

FIG. 9 is a sequence chart for describing a procedure for supporting communication in a system that supports 5G wireless communication and a satellite, according to an embodiment of the disclosure.

In FIG. 9, an operation of the UE sending a service request message to an AMF and a series of operations related to associated timers are described.

FIG. 9 corresponds to an occasion when the UE 101 receives information about both the 5G NR and the satellite RAT as an accessible RAT. Accordingly, it corresponds to a case that the UE 101 sets a timer value with the help of NR, i.e., the BS, when the UE is able to set both a value corresponding to the normal 5G NR and an extended timer value corresponding to the satellite RAT.

In this case, the UE 101 receives an extended timer value in an RRC complete message of RRC messages with the help of the AS layer, i.e., a message sent from the BS to the UE as in operations 900-1, 900-3 and 900-5. The UE 101 then forwards the received an extended timer value from the AS layer to the NAS layer to use the timer value.

In an embodiment, in operation 900-1, the UE 101 sends an RRC setup message to the 5G satellite RAN 104, and in operation 900-3, the UE 101 receives an RRC response message. In operation 900-5, when a cell to be camped on is determined while the UE 101 sends the RRC complete message to the 5G satellite RAN 104, the UE 101 may transmit a service request message of operation 901 while sending the RRC complete message of operation 900-5.

In another embodiment, the UE 101 may calculate an NAS timer value to be used in the NAS layer based on a T timer value used in the AS layer. In other words, there may be a method by which the UE 101 calculates an NAS timer value by multiplying the T timer value used in the AS layer and sends the NAS timer value to the NAS layer from the AS layer. In yet another embodiment, the UE 101 sends the T timer value from the AS layer to the NAS layer so that the NAS layer may set and use a timer value of the NAS layer based on the value of the AS layer.

In operations 901, 903 and 905, the UE 101 repairs disconnection of communication between the UE and the AMF by transmitting a service request message to the AMF 111.

In operations 901 and 903, the UE 101 transmits the service request message to the AMF 111. The registration request message is transmitted from the UE 101 to the AMF 111 through the 5G satellite RAN 104.

Referring to operations 901 and 903, as the UE 101 already completed registration through the initial registration procedure, the UE has information about an accessible RAT type in the corresponding region.

Accordingly, the UE 101 may transmit the service request message with the accessible RAT type information.

Referring to operations 901 and 903, the UE 101 notifies the AMF 111 of a capability of the UE 101 for the satellite RAN and an access RAT type indicating that it supports the satellite RAT type.
UE MM capability may include capability information about whether the UE supports the satellite RAN.
in another embodiment, the capability information indicating whether the UE supports the satellite RAN may be transmitted in an extra information element.
5G access type may include a 3GPP access type or a non-3GPP access type. Furthermore, for the 3GPP access type, the RAT type may include RAT types such as NR (normal 5G NR), SAT-LEO, SAT-MEO, SAT-GEO, SAT-Other, etc.
hence, using both the access type information and the RAT type information or using single information about the RAT type, the UE may notify the AMF of what capability it has to support the satellite RAN.
in another embodiment, the UE may designate and indicate a RAT type wanted to be used for registration. This may be a RAT type requested by the UE based on subscription of the UE.

TABLE 4
service request message

| IEI | Information Element | Type/Reference | Presence | Format | Length |
|---|---|---|---|---|---|
| | Extended protocol discriminator | Extended protocol discriminator | M | V | 1 |
| | Security header type | Security header type | M | V | ½ |
| | Spare half octet | Spare half octet | M | V | ½ |
| | Service request message identity | Message type | M | V | 1 |
| | ngKSI | NAS key set identifier | M | V | ½ |
| | Service type | Service type | M | V | ½ |
| | 5G-S-TMSI | 5GS mobile identity 9 | M | LV-E | 9 |
| | RAT type | | | | |
| | Access Type | | | | |
| | Satelite RAT Capable | | | | |

Referring to operation 905, an occasion when the UE 101 has information about a RAT type accessible by the UE 101 in the corresponding region.

Accordingly, the UE 101 may transmit a service request message with the accessible RAT type information.

Referring to operation 905, the UE 101 may determine whether T3517 is to be set to extended T3517 or normal T3517 depending on the RAT type.

In another embodiment, instead of the extended T3517, T35yy which serves as the extended T3517 may be set when the RAT type is a satellite RAN.

Alternatively or in yet another embodiment, the UE 101 may determine a value of the T3517 based on a RAT type supported in a TA recently visited by the UE based on information about the TA based on a last visited TAI.

Referring to operation 905, the UE 101 sets the T3517 in operation 905 in a case that the UE transmits a service request message to the AMF as in operations 901 and 903. The T3517 is a timer configured to be started when the UE 101 transmits the service request message and stopped when the UE 101 receives a service accept or a service reject message.
in an embodiment, the T3517 may be configured as in normal 5G NR.
in another embodiment, the T3517 may be an extended timer configured under the assumption of using the satellite NR.
alternatively or in yet another embodiment, when the UE receives an extended timer value from the AMF, the UE may store the value and set the T3517 based on the stored extended timer value.
in still another embodiment, when the UE receives, from the AMF, an indication indicating that timer extension is possible, the UE may set the T3517 by multiplication. In an embodiment, in the case of LEO, MEO and GEO, when the UE receives the timer extension indication, the timer may be set by multiplying a default value of the timer by a timer extension enabled multiple.

In operations 921, 923 and 925, the AMF 111 sends a service accept or service reject message to the UE 101.

In operations 921 and 923, the AMF 111 transmits the service accept or service reject message to the UE 101. The service accept or service reject message is transmitted from the AMF 111 to the UE 101 through the 5G satellite RAN 104.

In the case of the service accept message transmitted from the AMF the UE in operations 921 and 923 in particular, it may include information about a RAT type accessible by the UE an indication indicating whether timer extension of the UE is possible, extended priority, a timer extension value, etc.

TABLE 5
service accept message

| IEI | Information Element | Type/Reference | Presence | Format | Length |
|---|---|---|---|---|---|
| | Extended protocol discriminator | Extended protocol discriminator | M | V | 1 |
| | Security header type | Security header type | M | V | ½ |
| | Spare half octet | Spare half octet | M | V | ½ |
| | Service accept message identity | Message type | M | V | 1 |
| 50 | PDU session status | PDU session status | O | TLV | 4-34 |
| 25 | PDU session reactivation result | PDU session reactivation result | O | TLV | 4-34 |
| 72 | PDU session reactivation result | PDU session reactivation result | O | TLV-E | 5-515 |
| | error cause | error cause | | | |
| 78 | EAP message | EAP message | O | TLV-E | 7-1503 |
| | UE accessible RAT type | | | | |
| | Indication indicating whether | | | | |
| | timer extension of UE is possible | | | | |
| | RAT priority | | | | |
| | Extended T3517 value | | | | |
| | Timer extension value | | | | |
| | T3517 value | | | | |
| | New Timer T35yy value | | | | |

the UE accessible RAT type (or UE access allowable RAT type information element) is an information element, i.e., a parameter, indicated by the AMF (network) to the UE. The UE accessible RAT type information is to notify the UE, by the AMF, of information about a RAT type allowed for the UE. The information notified by the AMF to the UE may include the following details: 1) an indication of a RAT type supported by the network, 2) a RAT type that may be served by the network for the UE among information of “RAT types (lists) that may be supported by the UE”, which is notified by the UE to the network through information about a capability of the UE, and 3) information about a supportable RAT type notified by the AMF to the UE based on subscription information of the UE.
on receiving the information about a RAT type accessible by the UE, the UE may store the accessible RAT type information, and when transmitting a service request message later on, use the information to perform a service request procedure. For example, a function such as PLMN selection may be performed by selecting an accessible PLMN and RAT type when the service is requested.
an indication indicating whether timer extension of the UE is possible is notified for the UE to set the timer as an extended timer for the satellite RAT.
RAT priority (extended priority) is to give priority to a UE accessible RAT based on subscription of the UE, rule/regulation of a region/country, regional property (sea or a region with no BS), etc., when the UE accessible RAT includes 5G NR, satellite NR, etc.
timer expansion value may be set by multiplying a default value of the timer by a timer extension value when the UE receives the timer extension value from the network in setting the timer for a message to be transmitted by the UE to the AMF. In an embodiment, in the case of LEO, MEO and LEO, the timer may be set by multiplying the default value of the timer by a timer extension enabled multiple.
timer extension fixed value is to set and indicate a value to set a timer according to a RAT type accessed by the UE in setting the timer for a message to be transmitted by the UE to the AMF. The timer extension fixed value may be transmitted according to a value defined in a regulation or specification depending on whether the RAT type of the satellite NR is LEO, MEO, GEO, or other RAT type.

As shown in the operation in which the UE 101 receives the service accept or service reject message from the AMF 111, i.e., operation 925, the UE 101 stops the T3517 when the UE 101 receives the service accept or service reject message.

The timer extension fixed value may be transmitted in an information element of an extended T3517 value, a T3517 value or a new timer T35yy value. The extended T3517 value may be transmitted as a value determined according to the satellite, when the RAT is the satellite, transmitted by using a GPRS timer, a GPRS timer 2, GPRS timer 3, etc., transmitted as a multiple of the GPRS timer, the GPRS timer 2, or the GPRS timer 3, or transmitted in the form of a satellite timer by defining the satellite timer. Alternatively, for the T3517, when a RAT type is a normal 5G RAN for a RAT on which the UE camps, i.e., a RAT known by the AMF as the RAT on which the UE camps, the T3517 default value may be transmitted, and when the RAT type is a satellite RAT, an extended T3517 value may be transmitted.

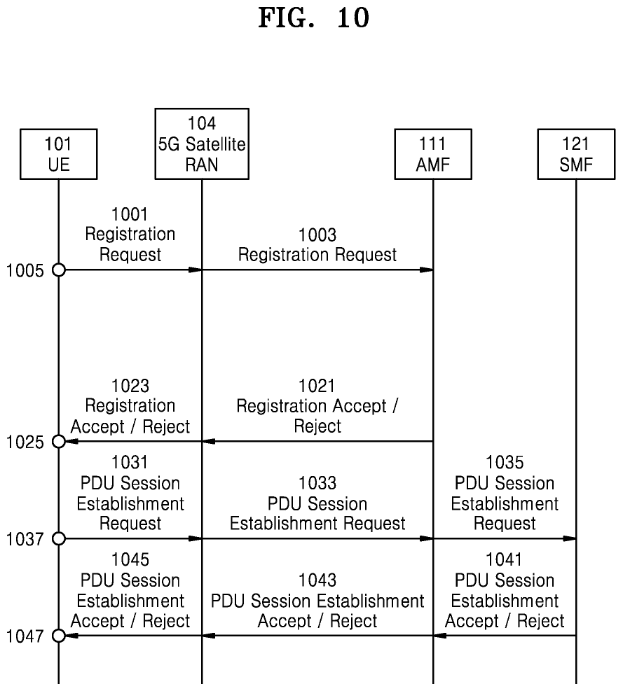

FIG. 10 is a sequence chart for describing a procedure for supporting communication in a system that supports 5G wireless communication and a satellite, according to an embodiment of the disclosure.

In FIG. 10, an operation of the UE 101 sending a PDU session establishment message to the SMF 121 and a series of operations related to associated timers are described.

In operations 1001, 1003 and 1005, the UE 101 sends a registration request to the AMF 111 and starts or configures to start the T3510, the extended T3510 or the T3510 set to have an extended timer value.

In operations 1001 and 1003, the UE 101 transmits the registration request message to the AMF 111. The registration request message is transmitted from the UE 101 to the AMF 111 through the 5G satellite RAN 104.

In operations 1021, 1023 and 1025, the UE 101 receives a registration accept or registration reject message from the AMF 111 and stops the T3510, the extended T3510 or the T3510 set to have an extended timer value.

In operations 1021 and 1023, the AMF 111 transmits the registration accept or registration reject message to the UE 101. The registration accept or registration reject message is transmitted from the AMF 111 to the UE 101 through the 5G satellite RAN 104.

In operations 1031, 1033, 1035 and 1037, the UE sends a PDU session establishment request to the SMF, and starts or configures to start the T3580, the extended T3580, or the T3580 set to have an extended timer value.

In operations 1031, 1033 and 1035, the UE 101 transmits the PDU session establishment request message to the SMF 121. The PDU session establishment request message is transmitted from the UE 101 to the SMF 121 through the 5G satellite RAN 104 and the AMF 111.

In operation 1037, the UE 101 starts or configures to start the T380, the extended T3580, or the T3580 set to have an extended timer value.

In this case, the UE 101 may set a value of the T3580 according to the RAT type of a RAN accessed by the UE 101. For example, the UE 101 may set the T3580 to have an extended value when the RAT type of the RAN accessed by the UE 101 is a satellite RAT.

Alternatively, the UE 101 may be configured with a value associated with the T3580 through the registration request message in the previous operation.

TABLE 6
registration accept message

| IEI | Information Element | Type/Reference | Presence | Format | Length |
|---|---|---|---|---|---|
| | Extended protocol discriminator | Extended protocol discriminator | M | V | 1 |
| | Security header type | Security header type | M | V | ½ |
| | Spare half octet | Spare half octet | M | V | ½ |
| | Registration accept message | Message type | M | V | 1 |
| | identity | | | | |
| | 5GS registration result | 5GS registration result | M | LV | 2 |
| 77 | 5G-GUTI | 5GS mobile identity | O | TLV-E | 14 |
| 4A | Equivalent PLMNs | PLMN list | O | TLV | 5-47 |
| 54 | TAI list | 5GS tracking area identity list | O | TLV | 9-114 |
| 21 | 5GS network feature support | 5GS network feature support | O | TLV | 3-5 |
| B- | MICO indication | MICO indication | O | TV | 1 |
| 9- | Network slicing indication | Network slicing indication | O | TV | 1 |
| 27 | Service area list | Service area list | O | TLV | 6-114 |
| 5D | Non-3GPP de-registration timer | GPRS timer 2 | O | TLV | 3 |
| | value | | | | |
| 67 | UE radio capability ID | UE radio capability ID | O | TLV | 3-n |
| E- | UE radio capability ID deletion | UE radio capability ID deletion | O | TV | 3 |
| | indication | indication | | | |
| | UE accessible RAT type | | | | |
| | Indication indicating whether | | | | |
| | timer extension of UE is possible | | | | |
| | RAT priority | | | | |
| | Extended T3510 value | | | | |
| | Timer extension value | | | | |
| | T3510 value | | | | |
| | New Timer T35xx value | | | | |
| | Extended T3580 value | | | | |
| | SM Timer extension value | | | | |
| | T3580 value | | | | |
| | New Timer T35aa value | | | | |
| | T3581 valuie | | | | |
| | T3582 value | | | | |
| | New timer T35bb value | | | | |
| | New timer T25cc value | | | | |

the UE accessible RAT type (or UE access allowable RAT type information element) is an information element, i.e., a parameter, indicated by the AMF (network) to the UE. The UE accessible RAT type information is to notify the UE, by the AMF, of information about a RAT type allowed for the UE. The information notified by the AMF to the UE may include the following details: 1) an indication of a RAT type supported by the network, 2) a RAT type that may be served by the network for the UE among information of “RAT types (lists) that may be supported by the UE”, which is notified by the UE to the network through information about a capability of the UE, and 3) information about a supportable RAT type notified by the AMF to the UE based on subscription information of the UE.

Such information may be notified.
on receiving the information about a RAT type accessible by the UE, the UE may store the accessible RAT type information, and when transmitting a registration request message later on, use the information to perform registration. In other words, a function such as PLMN selection may be performed by selecting an accessible PLMN and RAT type for registration.
an indication indicating whether timer extension of the UE is possible is notified for the UE to set the timer as an extended timer for the satellite RAT.
RAT priority (extended priority) is to give priority to a UE accessible RAT based on subscription of the UE, rule/regulation of a region/country, regional property (sea or a region with no BS), etc., when the UE accessible RAT includes 5G NR, satellite NR, etc.
timer expansion value may be set by multiplying a default value of the timer by a timer extension value when the UE receives the timer extension value from the network in setting the timer for a message to be transmitted by the UE to the AMF. In an embodiment, in the case of LEO, MEO and LEO, the timer may be set by multiplying the default value of the timer by a timer extension enabled multiple.
timer extension fixed value is to set and indicate a value to set a timer according to a RAT type accessed by the UE in setting the timer for a message to be transmitted by the UE to the AMF. The timer extension fixed value may be transmitted according to a value defined in a regulation or specification depending on whether the RAT type of the satellite NR is LEO, MEO, GEO, or other RAT type.
SM timer extension fixed value is to set and indicate a value to set a timer according to a RAT type accessed by the UE in setting the timer for a message to be transmitted by the UE to the SMF. For the SM timer extension fixed value, a timer extension fixed value may be transmitted according to a value defined in a regulation or specification depending on whether the RAT type of the satellite NR is LEO, MEO, GEO, or other RAT type. The timer extension fixed value may be transmitted in an information element of an extended T3580 value, a T3580 value or a new timer T35aa value. The extended T3580 value may be transmitted as a value determined according to the satellite, when the RAT is the satellite, transmitted by using a GPRS timer, a GPRS timer 2, GPRS timer 3, etc., transmitted as a multiple of the GPRS timer, the GPRS timer 2, or the GPRS timer 3, or transmitted in the form of a satellite timer by defining the satellite timer. Alternatively, for the T3580, when a RAT type is a normal 5G RAN for a RAT on which the UE camps, i.e., a RAT known by the AMF as the RAT on which the UE camps, a T3580 default value may be transmitted, and when the RAT type is a satellite RAT, an extended T3580 value may be transmitted.

TABLE 7
PDU session establishment request message

| IEI | Information Element | Type/Reference | Presence | Format | Length |
|---|---|---|---|---|---|
| | Extended protocol discriminator | Extended protocol discriminator | M | V | 1 |
| | PDU session ID | PDU session identity | M | V | 1 |
| | PTI | Procedure transaction identity | M | V | 1 |
| | PDU SESSION ESTABLISHMENT | Message type | M | V | 1 |
| | REQUEST message identity | | | | |
| | Integrity protection maximum | Integrity protection maximum | M | V | 2 |
| | data rate | data rate | | | |
| 9- | PDU session type | PDU session type | O | TV | 1 |
| A- | SSC mode | SSC mode | O | TV | 1 |
| 28 | 5GSM capability | 5GSM capability | O | TLV | 3-15 |
| 55 | Maximum number of supported | Maximum number of supported | O | TV | 3 |
| | packet filters | packet filters | | | |
| B- | Always-on PDU session | Always-on PDU session requested | O | TV | 1 |
| | requested | | | | |
| 39 | SM PDU DN request container | SM PDU DN request container | O | TLV | 3-255 |
| 7B | Extended protocol configuration | Extended protocol configuration | O | TLV-E | 4-65538 |
| | options | options | | | |
| | RAT type | | | | |

The UE may request establishment of a PDU session corresponding to the RAT type through the PDU session establishment request. This is to establish a PDU session for the corresponding RAT no matter whether the RAT type corresponds to the normal 5G NR or the satellite RAT.

In operations 1041, 1043, 1045 and 1047, the UE 101 receives a PDU session establishment accept or reject message from the SMF 121 and stops the T3580, the extended T3580 or the T3580 set to have an extended timer value.

In operations 1041, 1043 and 1045, the SMF 121 transmits the PDU session establishment accept or reject message to the UE 101. The PDU session establishment accept or reject message is transmitted from the SMF 121 to the UE 101 through the AMF 111 and the 5G satellite RAN 104.

TABLE 8
PDU session establishment accept

| IEI | Information Element | Type/Reference | Presence | Format | Length |
|---|---|---|---|---|---|
| | Extended protocol discriminator | Extended protocol discriminator | M | V | 1 |
| | PDU session ID | PDU session identity | M | V | 1 |
| | PTI | Procedure transaction identity | M | V | 1 |
| | PDU SESSION ESTABLISHMENT | Message type | M | V | 1 |
| | ACCEPT message identity | | | | |
| | Selected PDU session type | PDU session type | M | V | ½ |
| | Selected SSC mode | SSC mode | M | V | ½ |
| | Authorized QoS rules | QoS rules | M | LV-E | 6-65538 |
| | Session AMBR | Session-AMBR | M | LV | 7 |
| 59 | 5GSM cause | 5GSM cause | O | TV | 2 |
| 29 | PDU address | PDU address | O | TLV | 7-31 |
| 56 | RQ timer value | GPRS timer | O | TV | 2 |
| 22 | S-NSSAI | S-NSSAI | O | TLV | 3-10 |
| 8- | Always-on PDU session indication | Always-on PDU session indicate | O | TV | 1 |
| 75 | Mapped EPS bearer contexts | Mapped EPS bearer contexts | O | TLV-E | 7-65538 |
| 76 | EAP message | EAP message | O | TLV-E | 7-1503 |
| 79 | Authorized QoS flow descriptions | QoS flow descriptions | O | TLV-E | 6-65538 |
| 7B | Extended protocol configuration | Extended protocol configuration | O | TLV-E | 4-65538 |
| | options | options | | | |
| 25 | DNN | DNN | O | TLV | 3-102 |
| 17 | 5GSM network feature support | 5GSM network feature support | O | TLV | 3-15 |
| 18 | Serving PLMN rate control | Serving PLMN rate control | O | TLV | 4 |
| 77 | ATSSS container | ATSSS container | O | TLV-E | 3-65538 |
| C- | Control plane only indication | Control plane only indication | O | TV | 1 |
| | UE accessible RAT type | | | | |
| | Indication indicating whether | | | | |
| | SM timer extension is possible | | | | |
| | Extended T3580 value | | | | |
| | SM Timer extension value | | | | |
| | T3580 value | | | | |
| | New Timer T35ss value | | | | |
| | SM Extension timer indication | | | | |
| | T3581 valuie | | | | |
| | T3582 value | | | | |
| | New timer T35bb value | | | | |
| | New timer T35cc value | | | | |
| | RAT type | | | | |

alternatively, the UE may indicate an extended T3580 value, an SM timer extension value or a T3580 value in the PDU session establishment accept message.

The UE accessible RAT type (or UE access allowable RAT type information element) is an information element, i.e., a parameter, indicated by the AMF (network) to the UE. The UE accessible RAT type information is to notify the UE, by the AMF, of information about a RAT type allowed for the UE. The information notified by the AMF to the UE may include the following details: 1) an indication of a RAT type supported by the network, 2) a RAT type that may be served by the network for the UE among information of “RAT types (lists) that may be supported by the UE”, which is notified by the UE to the network through information about a capability of the UE, and 3) information about a supportable RAT type notified by the AMF to the UE based on subscription information of the UE.

Such information may be notified.
on receiving the information about the RAT type accessible by the UE, the UE may store the accessible RAT type information, and when transmitting a registration request message later on, use the information to perform registration. In other words, a function such as PLMN selection may be performed by selecting an accessible PLMN and RAT type for registration.
an indication indicating whether SM timer extension of the UE is possible is notified for the UE to set the timer as an extended timer for the satellite RAT.
RAT priority (extended priority) is to give priority to a UE accessible RAT based on subscription of the UE, rule/regulation of a region/country, regional property (sea or a region with no BS), etc., when the UE accessible RAT includes 5G NR, satellite NR, etc.
timer expansion value may be set by multiplying a default value of the timer by a timer extension value when the UE receives the timer extension value from the network in setting the timer for a message to be transmitted by the UE to the AMF. In an embodiment, in the case of LEO, MEO and LEO, the timer may be set by multiplying the default value of the timer by a timer extension enabled multiple.
timer extension fixed value is to set and indicate a value to set a timer according to a RAT type accessed by the UE in setting the timer for a message to be transmitted by the UE to the AMF. The timer extension fixed value may be transmitted according to a value defined in a regulation or specification depending on whether the RAT type of the satellite NR is LEO, MEO, GEO, or other RAT type.
alternatively, that a timer for satellite longer than a default SM timer needs to be used may be notified to the UE from the SMF through an SM timer extension indication. A timer affected by this is T3580, T351 or T3582, and the timer may be extended to fit the satellite on which the UE camps when there is the SM timer extension indication. In an embodiment, a method of multiplying the timer based on the type of satellite may be used.
in an embodiment, values of T35aa, T35bb and T35cc may correspond to T3580, T3581 and T3582, respectively, and may be set as extended new timer values for a PDU session establishment request, a PDU session modification request, or a PDU session release request when the RAT accessed by the UE is a satellite RAT. Depending on the type of satellite, the value may be transmitted by using a GPRS timer, a GPRS timer 2, GPRS timer 3, etc., transmitted as a multiple of the GPRS timer, the GPRS timer 2, or the GPRS timer 3, or transmitted in the form of a satellite timer by defining the satellite timer. Alternatively, for the T3580, T3581 and T3582, when a RAT type is a normal 5G RAN for a RAT on which the UE camps, i.e., a RAT known by the AMF as the RAT on which the UE camps, default values of T3580, T3581 and T3582 may be transmitted, and when the RAT type is a satellite RAT, an extended T3580 value, and extended T3581 value and an extended T3582 value may be transmitted.
SM timer extension fixed value is to set and indicate a value to set a timer according to a RAT type accessed by the UE in setting the timer for a message to be transmitted by the UE to the SMF. For the SM timer extension fixed value, the timer extension fixed value may be transmitted according to a value defined in a regulation or specification depending on whether the RAT type of the satellite NR is LEO, MEO, GEO, or other RAT type. The timer extension fixed value may be transmitted in an information element of an extended T3580 value, a T3580 value or a new timer T35aa value. The extended T3580 value may be transmitted as a value determined according to the satellite, when the RAT is the satellite, transmitted by using a GPRS timer, a GPRS timer 2, GPRS timer 3, etc., transmitted as a multiple of the GPRS timer, the GPRS timer 2, or the GPRS timer 3, or transmitted in the form of a satellite timer by defining the satellite timer. Alternatively, for the T3580, when a RAT type is a normal 5G RAN for a RAT on which the UE camps, i.e., a RAT known by the AMF as the RAT on which the UE camps, a T3580 default value may be transmitted, and when the RAT type is a satellite RAT, an extended T3580 value may be transmitted.
RAT type: the UE may request establishment of a PDU session corresponding to the RAT type through the PDU session establishment request. This is to establish a PDU session for the corresponding RAT no matter whether the RAT type corresponds to the normal 5G NR or the satellite RAT.

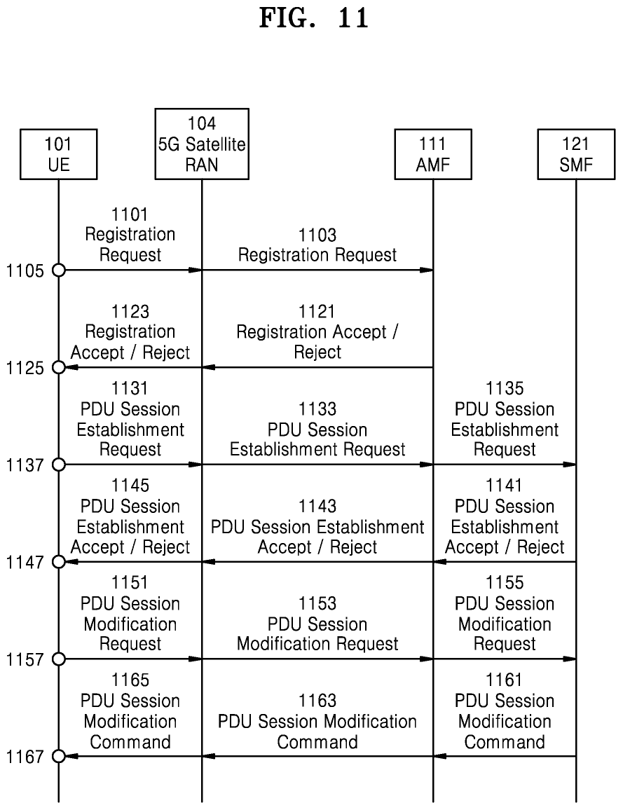

FIG. 11 is a sequence chart for describing a procedure for supporting communication in a system that supports 5G wireless communication and a satellite, according to an embodiment of the disclosure.

In FIG. 11, an operation of the UE sending a PDU session modification message to the SMF and a series of operations related to associated timers are described.

In operations 1101, 1103 and 1105, the UE 101 sends a registration request to the AMF 111 and starts or configures the T3510, the extended T3510 or the T3510 set to have an extended timer value to be started.

In operations 1101 and 1103, the UE 101 transmits the registration request message to the AMF 111. The registration request message is transmitted from the UE 101 to the AMF 111 through the 5G satellite RAN 104.

In operations 1121, 1123 and 1125, the UE 101 receives a registration accept message from the AMF 111 and stops the T3510, the extended T3510 or the T3510 set to have an extended timer value.

In operations 1121 and 1123, the AMF 111 transmits the registration accept or registration reject message to the UE 101. The registration accept or registration reject message is transmitted from the AMF 111 to the UE 101 through the 5G satellite RAN 104.

In operations 1131, 1133, 1135 and 1137, the UE 101 sends a PDU session establishment request to the SMF 121, and starts or configures to start the T3580, the extended T3580, or the T3580 set to have an extended timer value.

In operations 1131, 1133 and 1135, the UE 101 transmits the PDU session establishment request message to the SMF 121. The PDU session establishment request message is transmitted from the UE 101 to the SMF 121 through the 5G satellite RAN 104 and the AMF 111.

In operation 1137, the UE 101 starts or configures to start the T380, the extended T3580, or the T3580 set to have an extended timer value.

In operations 1141, 1143, 1145 and 1147, the UE 101 receives a PDU session establishment accept or reject message from the SMF 121 and stops the T3580, the extended T3580 or the T3580 set to have an extended timer value.

In operations 1141, 1143 and 1145, the SMF 121 transmits the PDU session establishment accept or reject message to the UE 101. The PDU session establishment accept or reject message is transmitted from the SMF 121 to the UE 101 through the AMF 111 and the 5G satellite RAN 104.

In operations 1151, 1153, 1155 and 1157, the UE 101 sends a PDU session modification request to the SMF 121, and starts or configures to start the T3581, the extended T3581 or the T3581 set to have an extended timer value or the T35bb.

In operations 1151, 1153 and 1155, the UE 101 transmits the PDU session modification request message to the SMF 121. The PDU session modification request message is transmitted from the UE 101 to the SMF 121 through the 5G satellite RAN 104 and the AMF 111.

In operation 1157, the UE 101 starts or configures to start the T381, the extended T3581, the T3581 set to have an extended timer value or the T35bb.

The T3581, the extended T3581, the T3581 set to have an extended timer value or the T35bb which is a new timer, may be found in SM related timer information in the registration accept received by the UE 101 as a response to the registration request, or SM timer related information received by the UE in the PDU session establishment accept message.

The UE 101 may request modification of the PDU session corresponding to the RAT type through the PDU session modification request. This is to modify the PDU session for the corresponding RAT no matter whether the RAT type corresponds to the normal 5G NR or the satellite RAT.

TABLE 9
PDU session modification request

| IEI | Information Element | Type/Reference | Presence | Format | Length |
|---|---|---|---|---|---|
| | Extended protocol discriminator | Extended protocol discriminator | M | V | 1 |
| | PDU session ID | PDU session identity | M | V | 1 |
| | PTI | Procedure transaction identity | M | V | 1 |
| | PDU SESSION MODIFICATION | Message type | M | V | 1 |
| | REQUEST message identity | | | | |
| 28 | 5GSM capability | 5GSM capability | O | TLV | 3-15 |
| 59 | 5GSM cause | 5GSM cause | O | TV | 2 |
| 55 | Maximum number of supported | Maximum number of supported | O | TV | 3 |
| | packet filters | packet filters | | | |
| B- | Always-on PDU session | Always-on PDU session requested | O | TV | 1 |
| | requested | | | | |
| 13 | Integrity protection maximum data | Integrity protection maximum data | O | TV | 3 |
| | rate | rate | | | |
| 7A | Requested QoS rules | QoS rules | O | TLV-E | 7-65538 |
| 79 | Requested QoS flow descriptions | QoS flow descriptions | O | TLV-E | 6-65538 |
| 75 | Mapped EPS bearer contexts | Mapped EPS bearer contexts | O | TLV-E | 7-65538 |
| 7B | Extended protocol configuration | Extended protocol configuration | O | TLV-E | 4-65538 |
| | options | options | | | |
| 74 | Port management information | Port management information | O | TLV-E | 4-65538 |
| | container | container | | | |
| | RAT type | | | | |

In operations 1161, 1163, 1165 and 1167, the UE 101 receives a PDU session modification command message from the SMF 121 and stops the T3581, the extended T3581 or the T381 set to have an extended timer value.

In operations 1161, 1163 and 1165, the SMF 121 transmits the PDU session modification command message to the UE 101. The PDU session modification command message is transmitted from the SMF 121 to the UE 101 through the AMF 111 and the 5G satellite RAN 104.

TABLE 10
PDU session modification command

| IEI | Information Element | Type/Reference | Presence | Format | Length |
|---|---|---|---|---|---|
| | Extended protocol discriminator | Extended protocol discriminator | M | V | 1 |
| | PDU session ID | PDU session identity | M | V | 1 |
| | PTI | Procedure transaction identity | M | V | 1 |
| | PDU SESSION MODIFICATION | Message type | M | V | 1 |
| | COMMAND message identity | | | | |
| 59 | 5GSM cause | 5GSM cause | O | TV | 2 |
| 2A | Session AMBR | Session-AMBR | O | TLV | 8 |
| 8- | Always-on PDU session indication | Always-on PDU session indication | O | TV | 1 |
| 7A | Authorized QoS rules | QoS rules | O | TLV-E | 7-65538 |
| 75 | Mapped EPS bearer contexts | Mapped EPS bearer contexts | O | TLV-E | 7-65538 |
| 79 | Authorized QoS flow descriptions | QoS flow descriptions | O | TLV-E | 6-65538 |
| 7B | Extended protocol configuration | Extended protocol configuration | O | TLV-E | 4-65538 |
| | options | options | | | |
| 77 | ATSSS container | ATSSS container | O | TLV-E | 3-65538 |

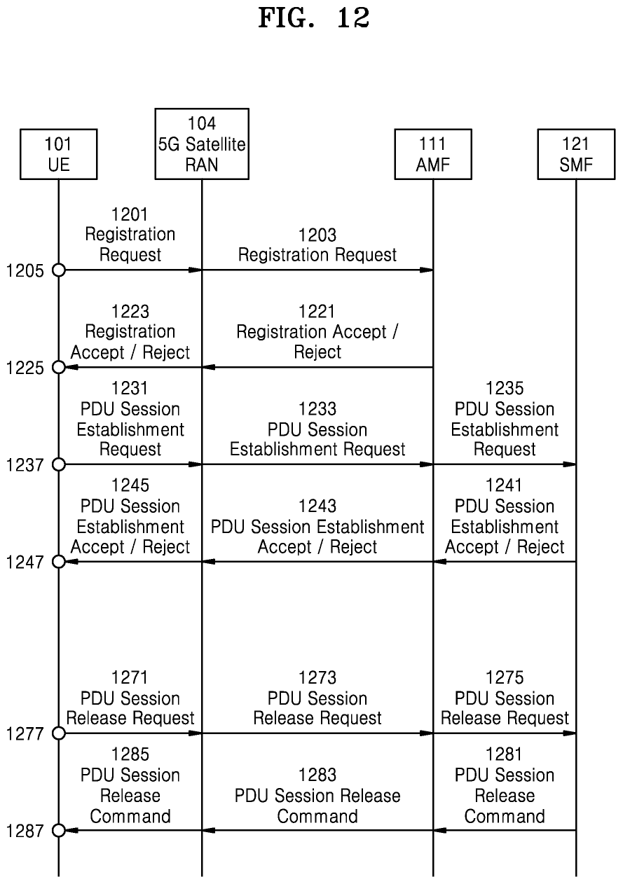

FIG. 12 is a sequence chart for describing a procedure for supporting communication in a system that supports 5G wireless communication and a satellite, according to an embodiment of the disclosure.

In FIG. 12, an operation of the UE 101 sending a PDU session release request message to the SMF 121 and a series of operations related to associated timers are described.

In operations 1201, 1203 and 1205, the UE 101 sends a registration request to the AMF 111 and starts or configures the T3510, the extended T3510 or the T3510 set to have an extended timer value to be started.

In operations 1201 and 1203, the UE 101 transmits the registration request message to the AMF 111. The registration request message is transmitted from the UE 101 to the AMF 111 through the 5G satellite RAN 104.

In operations 1221, 1223 and 1225, the UE 101 receives a registration response message from the AMF 111 and stops the T3510, the extended T3510 or the T3510 set to have an extended timer value.

In operations 1221 and 1223, the AMF 111 transmits the registration accept or registration reject message to the UE 101. The registration accept or registration reject message is transmitted from the AMF 111 to the UE 101 through the 5G satellite RAN 104.

In operations 1231, 1233, 1235 and 1237, the UE 101 sends a PDU session establishment request to the SMF 121, and starts or configures to start the T3580, the extended T3580, or the T3580 set to have an extended timer value.

In operations 1231, 1233 and 1235, the UE 101 transmits the PDU session establishment request message to the SMF 121. The PDU session establishment request message is transmitted from the UE 101 to the SMF 121 through the 5G satellite RAN 104 and the AMF 111.

In operation 1237, the UE 101 starts or configures the T380, the extended T3580, or the T3580 set to have an extended timer value to be started.

In operations 1241, 1243, 1245 and 1247, the UE 101 receives a PDU session establishment accept or reject message from the SMF 121 and stops the T3580, the extended T3580 or the T3580 set to have an extended timer value.

In operations 1241, 1243 and 1245, the SMF 121 transmits the PDU session establishment accept or reject message to the UE 101. The PDU session establishment accept or reject message is transmitted from the SMF 121 to the UE 101 through the AMF 111 and the 5G satellite RAN 104.

In operations 1271, 1273, 1275 and 1277, the UE 101 sends a PDU session release request to the SMF 121, and starts or configures to start the T3582, the extended T3582 or the T3582 set to have an extended timer value or the T35cc.

In operations 1271, 1273 and 1275, the UE 101 transmits the PDU session release request message to the SMF 121. The PDU session release request message is transmitted from the UE 101 to the SMF 121 through the 5G satellite RAN 104 and the AMF 111.

In operation 1277, the UE 101 starts or configures to start the T382, the extended T3582, the T3582 set to have an extended timer value or the T35cc.

The T3582, the extended T3582, the T3582 set to have an extended timer value or the T35cc which is a new timer, may be found in SM related timer information in the registration accept received by the UE as a response to the registration request, or SM timer related information received by the UE in the PDU session establishment accept message.

The UE 101 may request release of the PDU session corresponding to the RAT type through the PDU session release request. This is to release the PDU session for the corresponding RAT no matter whether the RAT type corresponds to the normal 5G NR or the satellite RAT.

TABLE 11
PDU session release request

| IEI | Information Element | Type/Reference | Presence | Format | Length |
|---|---|---|---|---|---|
| | Extended protocol discriminator | Extended protocol discriminator | M | V | 1 |
| | PDU session ID | PDU session identity | M | V | 1 |
| | PTI | Procedure transaction identity | M | V | 1 |
| | PDU SESSION RELEASE | Message type | M | V | 1 |
| | REQUEST message identity | | | | |
| 59 | 5GSM cause | 5GSM cause | O | TV | 2 |
| 7B | Extended protocol configuration | Extended protocol configuration | O | TLV-E | 4-65538 |
| | options | options | | | |
| | RAT type | | | | |

In operations 1281, 1283, 1285 and 1287, the UE 101 receives a PDU session release command message from the SMF 121 and stops the T3582, the extended T3582 or the T382 set to have an extended timer value.

In operations 1281, 1283 and 1285, the SMF 121 transmits the PDU session release command message to the UE 101. The PDU session release command message is transmitted from the SMF 121 to the UE 101 through the AMF 111 and the 5G satellite RAN 104.

In operation 1287, on receiving the PDU session release command, the UE 101 releases the PDU session corresponding to the RAT type. This is to release the PDU session for the corresponding RAT no matter whether the RAT type corresponds to the normal 5G NR or the satellite RAT.

TABLE 12
PDU session release command

| IEI | Information Element | Type/Reference | Presence | Format | Length |
|---|---|---|---|---|---|
| | Extended protocol discriminator | Extended protocol discriminator | M | V | 1 |
| | PDU session ID | PDU session identity | M | V | 1 |
| | PTI | Procedure transaction identity | M | V | 1 |
| | PDU SESSION RELEASE | Message type | M | V | 1 |
| | COMMAND message identity | | | | |
| | 5GSM cause | 5GSM cause | M | V | 1 |
| 37 | Back-off timer value | GPRS timer 3 | O | TLV | 3 |
| 78 | EAP message | EAP message | O | TLV-E | 7-1503 |
| 61 | 5GSM congestion re-attempt | 5GSM congestion re-attempt | O | TLV | 3 |
| | indicator | indicator | | | |
| 7B | Extended protocol configuration | Extended protocol configuration | O | TLV-E | 4-65538 |
| | options | options | | | |
| D- | Access type | Access type | O | TV | 1 |
| | RAT type | RAT type | | | |

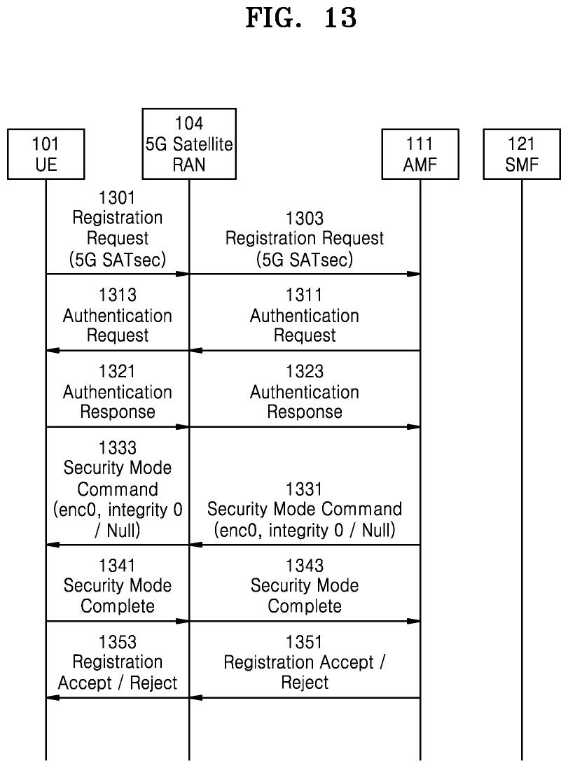

FIG. 13 is a sequence chart for describing a procedure for supporting communication in a system that supports 5G wireless communication and a satellite, according to an embodiment of the disclosure.

In FIG. 13, a series of operations related to a UE security procedure is described.

In operations 1301 and 1303, the UE 101 transmits a registration request message to the AMF 111.

In operations 1301 and 1303, the UE 101 transmits the registration request message to the AMF 111. The registration request message is transmitted from the UE 101 to the AMF 111 through the 5G satellite RAN 104.

In this case, when the UE 101 supports a 5G satellite RAT type, the UE 101 may transmit, to the AMF, information relating to supportable security with the 5G satellite RAT type.

In this case, when the UE requests an emergency service, 5G-SAT-IA0 is used for integrity protection and 5G-SAT-EA0 is used for encryption among the algorithms, i.e., null integrity protection for satellite and null encryption protection for satellite are used.

In other words, for the emergency service, the UE uses the null integrity protection for 5G satellite RAN access and the null encryption protection for 5G satellite RAN access, and these algorithms are applied in the NAS layer or the AS layer.

In an embodiment, a UE and AMF section uses 5G-EA0 and 5G-IA0 as a 5G security algorithm Through a procedure in which the AMF notifies the 5G satellite RAN of a security algorithm to be used in the 5G satellite RAN, the AS layer section uses the null integrity protection for 5G-SAT-EA0, 5G-SAT-IA0 5G satellite RAN access, i.e., null integrity protection for 5G satellite RAN access.

Alternatively, information about UE extended security capability as shown in the following tables is transmitted to the network. As shown in the following tables, Table 13, Table 14, Table 15 and Table 16, UE extended security capability may be coded in various formats, and coded information may be interpreted as in Table 17.

TABLE 13

| 8 | 7 | 6 | 5 | 4 | 3 | 2 | 1 | |
|---|---|---|---|---|---|---|---|---|
| UE extended security capability IEI | | | | | | | | octet 1 |
| Length of UE extended security capability contents | | | | | | | | octet 2 |
| 5G- | 128- | 128- | 128- | 5G- | 5G- | 5G- | 5G- | octet 3 |
| SAT- | 5G- | 5G- | 5G- | SAT- | SAT- | SAT- | SAT- | |
| EA0 | SAT- | SAT- | SAT- | EA4 | EA5 | EA6 | EA7 | |
| | EA1 | EA2 | EA3 | | | | | |
| 5G- | 128- | 128- | 128- | 5G- | 5G- | 5G- | 5G- | octet 4 |
| SAT- | 5G- | 5G- | 5G- | SAT- | SAT- | SAT- | SAT- | |
| IA0 | SAT- | SAT- | SAT- | IA4 | IA5 | IA6 | IA7 | |
| | IA1 | IA2 | IA3 | | | | | |

TABLE 14

| 8 | 7 | 6 | 5 | 4 | 3 | 2 | 1 | |
|---|---|---|---|---|---|---|---|---|
| UE extended security capability IEI | | | | | | | | octet 1 |
| Length of UE extended security capability contents | | | | | | | | octet 2 |
| 5G- | 128- | 128- | 128- | 5G- | 5G- | 5G- | 5G- | |
| SAT- | 5G- | 5G- | 5G- | SAT- | SAT- | SAT- | SAT- | |
| EA0 | SAT- | SAT- | SAT- | EA4 | EA5 | EA6 | EA7 | |
| | EA1 | EA2 | EA3 | | | | | |
| 5G- | 128- | 128- | 128- | 5G- | 5G- | 5G- | 5G- | |
| SAT- | 5G- | 5G- | 5G- | SAT- | SAT- | SAT- | SAT- | |
| IA0 | SAT- | SAT- | SAT- | IA4 | IA5 | IA6 | IA7 | |
| | IA1 | IA2 | IA3 | | | | | |
| 5G- | 128- | 128- | 128- | 5G- | 5G- | 5G- | 5G- | octet 3 |
| EA0 | 5G- | 5G- | 5G- | EA4 | EA5 | EA6 | EA7 | |
| | EA1 | EA2 | EA3 | | | | | |
| 5G-IA0 | 128- | 128- | 128- | 5G- | 5G- | 5G- | 5G- | octet 4 |
| | 5G- | 5G- | 5G- | IA4 | IA5 | IA6 | IA7 | |
| | IA1 | IA2 | IA3 | | | | | |
| EEA0 | 128- | 128- | 128- | EEA4 | EEA5 | EEA6 | EEA7 | octet 5* |
| | EEA1 | EEA2 | EEA3 | | | | | |
| EIA0 | 128- | 128- | 128- | EIA4 | EIA5 | EIA6 | EIA7 | octet 6* |
| | EIA1 | EIA2 | EIA3 | | | | | |
| 0 | 0 | 0 | 0 | 0 | 0 | 0 | 0 | octet 7*-10* |

Spare

TABLE 15

| 8 | 7 | 6 | 5 | 4 | 3 | 2 | 1 | |
|---|---|---|---|---|---|---|---|---|
| UE extended security capability IEI | | | | | | | | octet 1 |
| Length of UE extended security capability contents | | | | | | | | octet 2 |
| 5G- | 128- | 128- | 128- | 5G- | 5G- | 5G- | 5G- | octet 3 |
| EA0 | 5G- | 5G- | 5G- | EA4 | EA5 | EA6 | EA7 | |
| | EA1 | EA2 | EA3 | | | | | |
| 5G-IA0 | 128- | 128- | 128- | 5G- | 5G- | 5G- | 5G- | octet 4 |
| | 5G- | 5G- | 5G- | IA4 | IA5 | IA6 | IA7 | |
| | IA1 | IA2 | IA3 | | | | | |
| 5G- | 128- | 128- | 128- | 5G- | 5G- | 5G- | 5G- | |
| SAT | 5G- | 5G- | 5G- | SAT- | SAT- | SAT- | SAT- | |
| EA0 | SAT- | SAT- | SAT- | EA4 | EA5 | EA6 | EA7 | |
| | EA1 | EA2 | EA3 | | | | | |
| 5G- | 128- | 128- | 128- | 5G- | 5G- | 5G- | 5G- | |
| SAT- | 5G- | 5G- | 5G- | SAT- | SAT- | SAT- | SAT- | |
| IA0 | SAT- | SAT- | SAT- | IA4 | IA5 | IA6 | IA7 | |
| | IA1 | IA2 | IA3 | | | | | |
| EEA0 | 128- | 128- | 128- | EEA4 | EEA5 | EEA6 | EEA7 | octet 5* |
| | EEA1 | EEA2 | EEA3 | | | | | |
| EIA0 | 128- | 128- | 128- | EIA4 | EIA5 | EIA6 | EIA7 | octet 6* |
| | EIA1 | EIA2 | EIA3 | | | | | |
| 0 | 0 | 0 | 0 | 0 | 0 | 0 | 0 | octet 7*-10* |

Spare

TABLE 16

| 8 | 7 | 6 | 5 | 4 | 3 | 2 | 1 | |
|---|---|---|---|---|---|---|---|---|
| UE extended security capability IEI | | | | | | | | octet 1 |
| Length of UE extended security capability contents | | | | | | | | octet 2 |
| 5G- | 128- | 128- | 128- | 5G- | 5G- | 5G- | 5G- | octet 3 |
| EA0 | 5G- | 5G- | 5G- | EA4 | EA5 | EA6 | EA7 | |
| | EA1 | EA2 | EA3 | | | | | |
| 5G-IA0 | 128- | 128- | 128- | 5G- | 5G- | 5G- | 5G- | octet 4 |
| | 5G- | 5G- | 5G- | IA4 | IA5 | IA6 | IA7 | |
| | IA1 | IA2 | IA3 | | | | | |
| EEA0 | 128- | 128- | 128- | EEA4 | EEA5 | EEA6 | EEA7 | octet 5* |
| | EEA1 | EEA2 | EEA3 | | | | | |
| EIA0 | 128- | 128- | 128- | EIA4 | EIA5 | EIA6 | EIA7 | octet 6* |
| | EIA1 | EIA2 | EIA3 | | | | | |
| 5G- | 128- | 128- | 128- | 5G- | 5G- | 5G- | 5G- | |
| SAT- | 5G- | 5G- | 5G- | SAT- | SAT- | SAT- | SAT- | |
| EA0 | SAT- | SAT- | SAT- | EA4 | EA5 | EA6 | EA7 | |
| | EA1 | EA2 | EA3 | | | | | |
| 5G- | 128- | 128- | 128- | 5G- | 5G- | 5G- | 5G- | |
| SAT- | 5G- | 5G- | 5G- | SAT- | SAT- | SAT- | SAT- | |
| IA0 | SAT- | SAT- | SAT- | IA4 | IA5 | IA6 | IA7 | |
| | IA1 | IA2 | IA3 | | | | | |
| 0 | 0 | 0 | 0 | 0 | 0 | 0 | 0 | octet 7*-10* |

Spare

TABLE 17
5GS encryption algorithms supported (octet X)
5GS encryption algorithm 5G-SATEA0 supported (octet x, bit 8)

| | |
|---|---|
| 0 | 5GS encryption algorithm 5G-SAT-EA0 not supported |
| 1 | 5GS encryption algorithm 5G-SAT-EA0 supported |

5GS encryption algorithm 128-5G-SAT-EA1 supported (octet x, bit 7)

| | |
|---|---|
| 0 | 5GS encryption algorithm 128-5G-SAT-EA1 not supported |
| 1 | 5GS encryption algorithm 128-5G-SAT-EA1 supported |

5GS encryption algorithm 128-5G-SAT-EA2 supported (octet x, bit 6)

| | |
|---|---|
| 0 | 5GS encryption algorithm 128-5G-SAT-EA2 not supported |
| 1 | 5GS encryption algorithm 128-5G-SAT-EA2 supported |

5GS encryption algorithm 128-5G-SAT-EA3 supported (octet x, bit 5)

| | |
|---|---|
| 0 | 5GS encryption algorithm 128-5G-SAT-EA3 not supported |
| 1 | 5GS encryption algorithm 128-5G-SAT-EA3 supported |

5GS encryption algorithm 5G-SAT-EA4 supported (octet x, bit 4)

| | |
|---|---|
| 0 | 5GS encryption algorithm 5G-SAT-EA4 not supported |
| 1 | 5GS encryption algorithm 5G-SAT-EA4 supported |

5GS encryption algorithm 5G-SAT-EA5 supported (octet x, bit 3)

| | |
|---|---|
| 0 | 5GS encryption algorithm 5G-SAT-EA5 not supported |
| 1 | 5GS encryption algorithm 5G-SAT-EA5 supported |

5GS encryption algorithm 5G-SAT-EA6 supported (octet x, bit 2)

| | |
|---|---|
| 0 | 5GS encryption algorithm 5G-SAT-EA6 not supported |
| 1 | 5GS encryption algorithm 5G-SAT-EA6 supported |

5GS encryption algorithm 5G-SAT-EA7 supported (octet x, bit 1)

| | |
|---|---|
| 0 | 5GS encryption algorithm 5G-SAT-EA7 not supported |
| 1 | 5GS encryption algorithm 5G-SAT-EA7 supported |

5GS integrity algorithms supported (octet y)
5GS integrity algorithm 5G-SAT-IA0 supported (octet y, bit 8)

| | |
|---|---|
| 0 | 5GS integrity algorithm 5G-SAT-IA0 not supported |
| 1 | 5GS integrity algorithm 5G-SAT-IA0 supported |

5GS integrity algorithm 128-5G-SAT-IA1 supported (octet y, bit 7)

| | |
|---|---|
| 0 | 5GS integrity algorithm 128-5G-SAT-IA1 not supported |
| 1 | 5GS integrity algorithm 128-5G-SAT-IA1 supported |

5GS integrity algorithm 128-5G-SAT-IA2 supported (octet y, bit 6)

| | |
|---|---|
| 0 | 5GS integrity algorithm 128-5G-SAT-IA2 not supported |
| 1 | 5GS integrity algorithm 128-5G-SAT-IA2 supported |

5GS integrity algorithm 128-5G-SAT-IA3 supported (octet y, bit 5)

| | |
|---|---|
| 0 | 5GS integrity algorithm 128-5G-SAT-IA3 not supported |
| 1 | 5GS integrity algorithm 128-5G-SAT-IA3 supported |

5GS integrity algorithm 5G-SAT-IA4 supported (octet y, bit 4)

| | |
|---|---|
| 0 | 5GS integrity algorithm 5G-SAT-IA4 not supported |
| 1 | 5GS integrity algorithm 5G-SAT-IA4 supported |

5GS integrity algorithm 5G-SAT-IA5 supported (octet y, bit 3)

| | |
|---|---|
| 0 | 5GS integrity algorithm 5G-SAT-IA5 not supported |
| 1 | 5GS integrity algorithm 5G-SAT-IA5 supported |

5GS integrity algorithm 5G-SAT-IA6supported (octet y, bit 2)

| | |
|---|---|
| 0 | 5GS integrity algorithm 5G-SAT-IA6 not supported |
| 1 | 5GS integrity algorithm 5G-SAT-IA6 supported |

5GS integrity algorithm 5G-SAT-IA7 supported (octet y, bit 1)

| | |
|---|---|
| 0 | 5GS integrity algorithm 5G-SAT-IA7 not supported |
| 1 | 5GS integrity algorithm 5G-SAT-IA7 supported |

On receiving the message, the AMF stores the UE security capability and then informs the UE of a security algorithm supported by the AMF and also informs a 5G satellite RAN of the security algorithm when it supports the RAN, the 5G satellite RAN.

In other words, for the emergency service, null integrity protection and null encryption protection are used for a UE and AMF section and a UE and 5G satellite RAN section. The null integrity protection for 5G satellite RAN access and the null encryption protection for 5G satellite RAN access are used, and these algorithms are applied in the NAS layer or AS layer.

In an embodiment, a UE and AMF section uses 5G-EA0 and 5G-IAO as a 5G security algorithm Through a procedure in which the AMF notifies the 5G satellite RAN of a security algorithm to be used in the 5G satellite RAN, the UE and 5G satellite RAN section, i.e., the AS layer section, may use the null integrity protection for 5G-SAT-EA0 and 5G-SAT-IA0 5G satellite RAN access, i.e., null integrity protection for 5G satellite RAN access.

Alternatively, the UE and AMF section uses 5G-SAT-EA0 and 5G-SAT-TAO as a 5G satellite security algorithm Through a procedure in which the AMF notifies the 5G satellite RAN of a security algorithm to be used in the 5G satellite RAN, the UE and 5G satellite RAN section, i.e., the AS layer section, may use the null integrity protection for 5G-SAT-EA0 and 5G-SAT-IA0 5G satellite RAN access, i.e., null integrity protection for 5G satellite RAN access.

In operations 1311 and 1313, the AMF 111 transmits an authentication request message to the UE 101.

In operations 1321 and 1323, the UE 101 transmits an authentication response message to the AMF 111.

In operations 1331 and 1333, the AMF 111 transmits a security mode command message to the UE 101.

In operations 1341 and 1343, the UE 101 transmits a security mode complete to the AMF 111.

In operations 1351 and 1353, the AMF 111 transmits a registration response message to the UE 101.

In operations 1351 and 1353, the AMF 111 transmits the registration accept or registration reject message to the UE 101. The registration accept or registration reject message is transmitted from the AMF 111 to the UE 101 through the 5G satellite RAN 104.

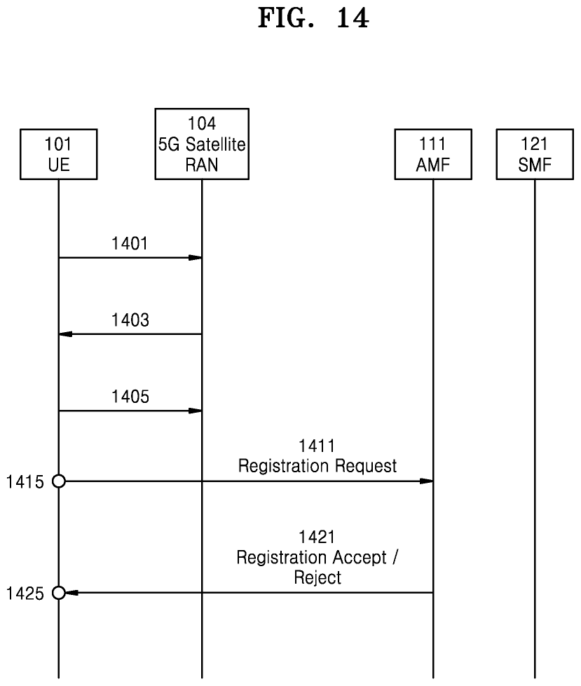

FIG. 14 is a sequence chart for describing a procedure for supporting communication in a system that supports 5G wireless communication and a satellite, according to an embodiment of the disclosure.

In FIG. 14, an operation of the UE sending a registration request message to an AMF and an operation related to PLMN selection are described.

FIG. 14 corresponds to an occasion when the UE 101 receives information about both the 5G NR and the satellite RAT as the accessible RAT. Accordingly, it corresponds to a case that the UE 101 sets a timer value with the help of NR, i.e., the BS, when the UE is able to set both a value corresponding to the normal 5G NR and an extended timer value corresponding to the satellite RAT.

In other words, it is a case that the UE receives information about one of the 5G NR and the satellite RAT as an accessible RAT. Accordingly, it may allow the UE to set a timer value corresponding to the 5G satellite.

In this case, the UE 101 receives a value of whether timer is extended in an RRC complete message of RRC messages with the help of the AS layer, i.e., a message sent from the BS 104 to the UE 101, as in operations 1401, 1403 and 1405. The UE 101 may then forward the received value of whether timer is extended from the AS layer to the NAS layer to use the timer value.

In an embodiment, in operation 1401, the UE 101 sends an RRC setup message to the 5G satellite RAN 104, and in operation 1403, the UE 101 receives an RRC response message. As in operation 1405, when a cell to be camped on is determined while the UE 101 sends the RRC complete message to the 5G satellite RAN 104, the UE 101 may transmit a registration request message of operation 1411 while sending the RRC complete message.

That is, in operation 1401, the UE transmits an RRC connection request message to the 5G satellite RAN. This is an attempt of the UE to make a call, to transmit data, or to make an RRC connection to respond to paging in an idle state.

In operation 1403, the UE receives an RRC connection setup message, which is a response message from the 5G satellite RAN. This is a case that the 5G satellite RAN accepts the connection request of the UE.

In operation 1405, the UE transmits an RRC connection setup complete message to the 5G satellite RAN and switches into an RRC connection mode.

Specifically, a message transmitted in operation 1405 may be an RRC message to be sent to the 5G satellite RAN from the UE, and the RRC message may include a registration request message transmitted in operation 1411, or the registration request message may be carried on the RRC message, or the registration request message, which is an NAS message, may be carried on the RRC message by piggyback or concatenation.

In another embodiment, the UE 101 may calculate an NAS timer value to be used in the NAS layer based on a T timer value used in the AS layer. In an embodiment, there may be a method by which the UE 101 calculates an NAS timer value by multiplying the T timer value used in the AS layer and sends the NAS timer value to the NAS layer from the AS layer.

In yet another embodiment, the UE 101 sends the T timer value from the AS layer to the NAS layer so that the NAS layer may set and use a timer value of the NAS layer based on the value of the AS layer.

The following procedure is performed in relation to selecting a PLMN. The PLMN may be identified with a mobile country code (MCC) and a mobile network code (MNC). PLMN information of the cell is broadcast in system information.

When powered on in the beginning stage, the UE searches for an available PLMN and selects a suitable PLMN from which to receive services. The NAS layer of the UE informs the AS layer that PLMN selection is required. The AS layer searches for a corresponding band and informs the NAS layer of a PLMN list. The NAS layer of the UE may select a PLMN to register the UE therewith according to PLMN/RAT selection priority stored in the user service identity module (USIM).

The UE may find a suitable cell among the cells to which the PLMN belongs and select the cell to provide a suitable service. The suitable cell is a cell from which the UE receives a suitable service, which needs to be an acceptable cell and simultaneously a cell having to belong to a PLMN to which the UE may access and not preventing the UE from performing the registration procedure. Furthermore, when the cell is a closed access group (CAG) cell, it may be accessible as the UE is a CAG member.

A cell from which the UE may receive a limited service is called an acceptable cell. The acceptable cell is a cell on which the UE is not prevented from camping and which satisfies a cell selection standard of the UE. In other words, the acceptable cell is a cell that satisfies signal strength or signal quality. An occasion when the UE receives a limited service corresponds to a case of receiving a service related to emergency calls or earthquake and tsunami warning system (ETWS), and the service may be provided by the acceptable cell.

This is an automatic PLMN selection method.

The priority is as follows:
home PLMN (HPLMN), equivalent HPLMN, recommended PLMN, target PLMN or candidate PLMN
alternatively, HPLMN, equivalent HPLMN, recommended PLMN and access technology, target PLMN and access technology, or candidate PLMN and access technology
the HPLMN may be a PLMN having an MCC mapped to an MCC and an MNC of a UE international mobile subscriber identity (IMSI).
the equivalent HPLMN (EHPLMN) may be a PLMN treated as an equivalent to the HPLMN.
the recommended PLMN, target PLMN or candidate PLMN is a target or candidate PLMN for registration, which is recommended for the UE to register with. The recommended PLMN, target PLMN or candidate PLMN is a target or candidate PLMN for registration, which is recommended for the UE to register with in the corresponding region according to a regulatory or a satellite use agreement. It may be a PLMN including a country code MCC, a 90x code, a 9xx code, or the like allowed to be used by the UE in the corresponding region according to a regulatory, an agreement between countries, or the satellite use agreement, or in the current location.
user controlled PLMN and access technology
operator controlled PLMN and access technology
a PLMN reported by the AS as a high quality PLMN
as another method, there is a manual PLMN selection method, which is a method of selecting, by the user, a PLMN from a PLMN list provided by the AS layer of the UE.
once the UE successfully completes location registration, the selected PLMN becomes registered PLMN (RPLMN), which is a PLMN with which location registration is successfully completed. The EPLMN is a PLMN treated as the equivalent to the RPLMN. Furthermore, a visited PLMN (VPLMN) is a PLMN that provides a service to the UE while the UE is in a roaming state.

When it is at least one of occasions when the UE is in a limited service state, the UE is unable to receive a normal service from the PLMN, the UE fails to find a suitable cell, or the UE is trying to make an emergency call or using the ETWS service, the UE needs to camp on the acceptable cell to register with the network.

In an embodiment, the following conditions 1) to 4) are satisfied, the UE is able to camp on the cell and register with the network.

Condition 1) when the UE registers with the network and it is at least one of the occasions when the UE is in a limited service state, the UE is unable to receive a normal service from the PLMN or the UE fails to find a suitable cell, the UE needs to camp on the acceptable cell.

Condition 2) in this case, when an RAT type or RAN type (or RAN) to be accessed is the 5G satellite RAN,

Condition 3) when the 5G satellite RAN is an acceptable cell, and

Condition 4) when an emergency center, a core network, or the like belongs to a country where the UE is physically located or an MCC PLMN where the UE is physically located, the UE is able to camp on the 5G satellite RAN acceptable cell or register with the PLMN. Alternatively, when the aforementioned conditions 1) to 4) are satisfied, the UE needs to camp on the 5G satellite RAN acceptable cell and register with the PLMN.

In another embodiment, the following conditions 1) to 4) are satisfied, the UE is able to camp on the cell and register with the network.

Condition 1) when it is at least one of the occasions when the UE is in a limited service state, the UE is unable to receive a normal service from the PLMN or the UE fails to find a suitable cell, the UE needs to camp on the acceptable cell.

Condition 2) when an MCC of a PLMN or a country of the PLMN corresponding to a current location of the UE is not an MCC, country or PLMN to which registration is allowed, or is not a country, MCC or PLMN to which the current location of the UE is not allowed for registration according the country's regulation or other constraints,

Condition 3) when an RAT type or RAN type (or RAN) is the 5G satellite RAN, and

Condition 4) when the cell is one and only acceptable cell in the country or MCC where the UE is physically located, or when an acceptable cell of the 5G satellite RAN is a 5G satellite RAN acceptable cell belonging to a PLMN of the network in the country or MCC where the UE is physically located, the UE needs to camp on the cell. When the aforementioned conditions 1) to 4) are met, the UE is able to or needs to register with the PLMN.

When the UE is in a situation to camp on an acceptable cell while in a limited service state, an automatic PLMN selection method is as follows.

Priorities of PLMNs selected by the automatic PLMN selection method are as follows:

First priority: condition a) when the UE is in a limited service state, and
condition b) the acceptable cell on which the UE is able to camp is a 5G RAN satellite acceptable cell, or the only acceptable cell on which the UE is able to camp is the 5G RAN satellite acceptable cell,
condition c) even when the PLMN with which the UE is going to register is not an HPLMN, an EHPLMN, a recommended PLMN, a target PLMN or a candidate PLMN with which the UE is able to register for a suitable service,
condition d-1) when the PLMN is a PLMN having one and only 5G satellite RAN acceptable cell with which the UE is able to register in the physical location, the UE registers with the PLMN in the limited service state.

Alternatively, even when conditions a), b) and c) are satisfied but condition d-1) is not met, condition d-2) when the current physical location of the UE has an emergency center or a core network to which the PLMN provides an emergency service, and the PLMN has a 5G satellite RAN acceptable cell, the UE registers with the PLMN in the limited service state.

Second priority: when the UE is in the limited service state and there is the following PLMN, the PLMN may have the second priority to be selected. In this case, although the UE is in the limited service state, there may be information about the following PLMN:
HPLMN, EHPLMN, recommended PLMN, target PLMN or candidate PLMN
alternatively, HPLMN, EHPLMN, recommended PLMN and access technology, target PLMN and access technology, or candidate PLMN and access technology

The HPLMN may be a PLMN having an MCC mapped to an MCC and an MNC of a UE IMSI.

The EHPLMN may be a PLMN treated as an equivalent to the HPLMN.

The recommended PLMN, target PLMN or candidate PLMN is a target or candidate PLMN for registration, which is recommended for the UE to register with. The recommended PLMN, target PLMN or candidate PLMN is a target or candidate PLMN for registration, which is recommended for the UE to register with in the corresponding region according to a regulatory or a satellite use agreement. It may be a PLMN including a country code MCC, a 90x code, a 9xx code, or the like allowed to be used by the UE in the corresponding region according to a regulatory, an agreement between countries, or the satellite use agreement, or in the current location.

Third priority: user controlled PLMN and access technology

Fourth priority: operator controlled PLMN and access technology

Fifth priority: a PLMN reported by the AS as a high quality PLMN

UE may select a cell which broadcasts the PLMN and attempt to register with the selected PLMN by transmitting a registration request message.

The PLMN broadcast by the 5G satellite RAN may be as follows.

As shown in FIG. 1B, as a PLMN includes an MCC and an MNC when the satellite RAN covers many neighboring countries, the PLMN is configured to include the MCC indicating a certain country and the MNC indicating a certain operator or certain network. For example, when A, B and C adjoin each other as in FIG. 1B and a satellite RAN covers the countries A, B and C as in FIG. 1B, the PLMN may include a certain MCC and an MNC of the MCC. For example, it may include MCC A and an MNC belonging to the MCC A.

In another embodiment, the PLMN may include an MCC starting with 90X used for satellite MCC to indicate a satellite 5G RAN, and an MNC indicating a certain operator.

In yet another embodiment, the PLMN may include an MCC starting with 9XX used for satellite MCC to indicate a satellite 5G RAN, and an MNC indicating a certain operator.

When the UE fails to find a suitable cell in the selected PLMN, has no USIM, receives a response of ‘PLMN not allowed’ or ‘illegal UE’ to the registration request, or receives a response of ‘IMSI unknown in HSS’, or power saving mode is activated, the UE may receive a service from the selected PLMN while in a limited service state.

In operation 1411, the UE 101 registers itself by transmitting a registration request message to the AMF 111.

In operation 1411, the UE 101 transmits the registration request message to the AMF 111. The registration request message is transmitted from the UE 101 to the AMF 111 through the 5G satellite RAN 104.

Referring to operation 1411, when the UE already completes registration through the initial registration procedure, the UE may have had information about an accessible RAT type in the corresponding region.

Accordingly, the UE 101 may transmit the registration request message with the accessible RAT type information.

Referring to operation 1411, the UE 101 notifies the AMF 111 of a capability of the UE 101 for the satellite RAN and an access RAT type indicating that it supports the satellite RAT type.
UE MM capability may include capability information about whether the UE supports the satellite RAN. The information may be notified by using an indication, Satellite RATCapable.
in another embodiment, the capability information indicating whether the UE supports the satellite RAN may be transmitted in an extra information element. The information may be notified by using the indication Satellite RATCapable.
5G access type may include a 3GPP access type or a non-3GPP access type. Furthermore, for the 3GPP access type, the RAT type may include RAT types such as NR (normal 5G NR), SAT-LEO, SAT-MEO, SAT-GEO, SAT-Other, etc.
hence, using both the access type information and the RAT type information or using single information about the RAT type, the UE may notify the AMF of what capability it has to support the satellite RAN.
in another embodiment, the UE may designate and indicate a RAT type wanted to be used for registration. This may be a RAT type requested by the UE based on subscription of the UE.

TABLE 18
registration request message

| IEI | Information Element | Type/Reference | Presence | Format | Length |
|---|---|---|---|---|---|
| | Extended protocol discriminator | Extended Protocol discriminator | M | V | 1 |
| | Security header type | Security header type | M | V | ½ |
| | Spare half octet | Spare half octet | M | V | ½ |
| | Registration request message | Message type | M | V | 1 |
| | identity | | | | |
| | 5GS registration type | 5GS registration type | M | V | ½ |
| | ngKSI | NAS key set identifier | M | V | ½ |
| | 5GS mobile identity | 5GS mobile identity | M | LV-E | 6-n |
| C- | Non-current native NAS key set | NAS key set identifier | O | TV | 1 |
| | identifier | | | | |
| 10 | 5GMM capability | 5GMM capability | O | TLV | 3-15 |
| 2E | UE security capability | UE security capability | O | TLV | 4-10 |
| 2F | Requested NSSAI | NSSAI | O | TLV | 4-74 |
| 52 | Last visited registered TAI | 5GS tracking area identity | O | TV | 7 |
| 6A | T3324 value | GPRS timer 3 | O | TLV | 3 |
| | RAT type | | | | |
| | Access Type | | | | |
| | Satelite RAT Capable | | | | |

TABLE 19
5GMM capability

| 8 | 7 | 6 | 5 | 4 | 3 | 2 | 1 | |
|---|---|---|---|---|---|---|---|---|
| 5GMM capability IEI | | | | | | | | octet 1 |
| Length of 5GMM capability contents | | | | | | | | octet 2 |
| SGC | 5G- | N3 | 5G-CPCIoT | RestrictEC | LPP | HO | S1 | octet 3 |
| | IPHC- | data | | | | attach | mode | |
| | CPCIoT | | | | | | | |
| RACS | NSSAA | 5G- | V2XCNPC5 | V2XCEPC5 | V2X | 5G- | 5GSRVCC | octet 4* |
| | | LCS | | | | UPCIoT | | |
| 0 | 0 | Satelite | ER- | 5G- | multipleUP | WUSA | CAG | |
| | | RAT | NSSAI | EHC- | | | | |
| | | Capable | | CPCIoT | | | | |
| 0 | 0 | 0 | 0 | 0 | 0 | 0 | 0 | octet 6*-15* |

Spare

Referring to operation 1415, when the UE 101 already completes registration through an initial registration procedure, the UE 101 may perform a periodic registration request.

Alternatively, the UE 101 may perform registration through the initial registration procedure.

The UE 101 has information about an accessible RAT type in the corresponding region.

Accordingly, the UE 101 may transmit a registration request message with the accessible RAT type information.

Hence, referring to operation 1415, the UE 101 may determine whether T3510 is to be set to extended T3510 or normal T3510 depending on the RAT type.

In another embodiment, instead of the extended T3510, the UE 101 may set T35xx which serves as the extended T3510 when the RAT type is a satellite RAN.

In yet another embodiment, the UE 101 may determine a value of the T3510 based on a RAT type supported in a TA recently visited by the UE based on information about the TA based on a last visited TAI.

Referring to operation 1415, the UE 101 sets the T3510 in operation 1415 in a case that the UE transmits a registration request message to the AMF as in operations 1411. The T3510 is a timer configured to be started when the UE 101 transmits the registration request message and stopped when the UE 101 receives a registration accept or a registration reject message.
in an embodiment, the T3510 may be configured as in the case of normal 5G NR.
in another embodiment, the T3510 may be an extended timer configured under the assumption of using the satellite NR.
in yet another embodiment, when the UE receives an extended timer value from the AMF, the UE may store the received extended time value and set the T3510 based on the stored extended timer value.
in still another embodiment, when the UE receives, from the AMF, an indication indicating that timer extension is possible, the UE may set the T3510 by multiplication. In an embodiment, in the case of LEO, MEO and GEO, when the UE receives the timer extension indication, the timer may be set by multiplying a default value of the timer by a timer extension enabled multiple.

In operation 1421, the AMF 111 sends a registration accept or registration reject message to the UE 101.

In operation 1421, the AMF 111 transmits the registration accept or registration reject message to the UE 101. The registration accept or registration reject message is transmitted from the AMF 111 to the UE 101 through the 5G satellite RAN 104.

The registration accept message transmitted from the AMF 111 to the UE 101 in operation 1421 may include information about a RAT type accessible by the UE 101, an indication indicating whether timer extension of the UE 101 is possible, extended priority, a timer extension value, etc.

TABLE 20
registration accept message

| IEI | Information Element | Type/Reference | Presence | Format | Length |
|---|---|---|---|---|---|
| | Extended protocol discriminator | Extended protocol discriminator | M | V | 1 |
| | Security header type | Security header type | M | V | ½ |
| | Spare half octet | Spare half octet | M | V | ½ |
| | Registration accept message | Message type | M | V | 1 |
| | identity | | | | |
| | 5GS registration result | 5GS registration result | M | LV | 2 |
| 77 | 5G-GUTI | 5GS mobile identity | O | TLV-E | 14 |
| 4A | Equivalent PLMNs | PLMN list | O | TLV | 5-47 |
| 54 | TAI list | 5GS tracking area identity list | O | TLV | 9-114 |
| 21 | 5GS network feature support | 5GS network feature support | O | TLV | 3-5 |
| B- | MICO indication | MICO indication | O | TV | 1 |
| 9- | Network slicing indication | Network slicing indication | O | TV | 1 |
| 27 | Service area list | Service area list | O | TLV | 6-114 |
| 5D | Non-3GPP de-registration timer | GPRS timer 2 | O | TLV | 3 |
| | value | | | | |
| 57 | UE radio capability ID | UE radio capability ID | O | TLV | 3-n |
| E- | UE radio capability ID deletion | UE radio capability ID deletion | O | TV | 1 |
| | indication | indication | | | |
| | UE accessible RAT type | | | | |
| | Indication indicating whether | | | | |
| | time extension of UE is possible | | | | |
| | RAT priority | | | | |
| | Extended T3510 value | | | | |
| | Timer extension value | | | | |
| | T3510 value | | | | |
| | New Timer T35xx value | | | | |

the UE accessible RAT type (or UE access allowable RAT type information element) is an information element, i.e., a parameter, indicated by the AMF (network) to the UE. The UE accessible RAT type information is to notify the UE, by the AMF, of information about a RAT type allowed for the UE. The information notified by the AMF to the UE may include the following details: 1) an indication of a RAT type supported by the network, 2) a RAT type that may be served by the network for the UE among information of “RAT types (lists) that may be supported by the UE”, which is notified by the UE to the network through information about a capability of the UE, and 3) information about a supportable RAT type notified by the AMF to the UE based on subscription information of the UE.

Such information may be notified.
on receiving the information about a RAT type accessible by the UE, the UE may store the accessible RAT type information, and when transmitting a registration request message later on, use the information to perform registration. The UE may perform a function such as PLMN selection by selecting an accessible PLMN and RAT type for registration.
an indication indicating whether timer extension of the UE is possible is notified for the UE to set the timer as an extended timer for the satellite RAT.
RAT priority (extended priority) is to give priority to a UE accessible RAT based on subscription of the UE, rule/regulation of a region/country, regional property (sea or a region with no BS), etc., when the UE accessible RAT includes 5G NR, satellite NR, etc.
timer expansion value may be set by multiplying a default value of the timer by a timer extension value when the UE receives the timer extension value from the network in setting the timer for a message to be transmitted by the UE to the AMF. In an embodiment, in the case of LEO, MEO and LEO, the timer may be set by multiplying the default value of the timer by a timer extension enabled multiple.
timer extension fixed value is to set and indicate a value to set a timer according to a RAT type accessed by the UE in setting the timer for a message to be transmitted by the UE to the AMF. The timer extension fixed value may be transmitted according to a value defined in a regulation or specification depending on whether the RAT type of the satellite NR is LEO, MEO, GEO, or other RAT type.
the timer extension fixed value may be transmitted in an information element of an extended T3510 value, a T3510 value or a new timer T35xx value. The extended T3510 value may be transmitted as a value determined according to the satellite, when the RAT is the satellite, transmitted by using a GPRS timer, a GPRS timer 2, GPRS timer 3, etc., transmitted as a multiple of the GPRS timer, the GPRS timer 2, or the GPRS timer 3, or transmitted in the form of a satellite timer by defining the satellite timer. Alternatively, for the T3510, when a RAT type is a normal 5G RAN for a RAT on which the UE camps, i.e., a RAT known by the AMF as the RAT on which the UE camps, a T3510 default value may be transmitted, and when the RAT type is a satellite RAT, an extended T3510 value may be transmitted.

Subsequent operation 1421 is a case that a registration reject message is transmitted from the AMF to the UE. In other words, in operation 1421, the AMF may send the registration reject message to the UE when registration is not allowed for the UE. The registration reject message may include one or two or more of IEs shown in Table 21, i.e., some of the IEs shown in Table 21 may be included in the registration reject message.

TABLE 21
registration reject message

| IEI | Information Element | Type/Reference | Presence | Format | Length |
|---|---|---|---|---|---|
| | Extended protocol discriminator | Extended protocol discriminator | M | V | 1 |
| | Security header type | Security header type | M | V | ½ |
| | Spare half octet | Spare half octet | M | V | ½ |
| | Registration reject message identity | Message type | M | V | 1 |
| | 5GMM cause | 5GMM cause | M | V | 1 |
| | T3346 value | GPRS timer 2 | O | TLV | 3 |
| | T3502 value | GPRS timer 2 | O | TLV | 3 |
| | EAP message | EAP message | O | TLV-E | 7-1503 |
| | Rejected NSSAI | Rejected NSSAI | O | TLV | 4-42 |
| | CAG information list | CAG information list | O | TLV-E | 3-n |
| | Extended rejected NSSAI | Extended rejected NSSAI | O | TLV | 4-74 |
| | Current location MCC list | | | | |
| | Candidate MCC list | | | | |
| | Forbidden MCC list | | | | |
| | Cause | | | | |
| | UE accessible RAT type | | | | |
| | Indication indicating whether | | | | |
| | time extension of UE is possible | | | | |
| | RAT priority | | | | |
| | Extended T3510 value | | | | |
| | Timer extension value | | | | |
| | T3510 value | | | | |
| | New Timer T35xx value | | | | |

There are following embodiments of an MCC list transmitted in a parameter, information element, in the registration reject message.

In an embodiment,

Case 1 is that the AMF notifies the UE of an MCC of the current location so that the UE selects and access a PLMN having an MCC corresponding to the current location. The AMF may send an MCC of the current location of the UE by sending the registration reject message to the UE.

For example, when the UE accesses the AMF at a location in country A, the AMF may send an MCC of the country A. In other words, the AMF may send an MCC list corresponding to the country where the UE is located.

On receiving the MCC list, the UE uses the MCC list to modify the MCC of the location of the UE. Specifically, on receiving the MCC list, the UE selects a PLMN including the received MCC and performs registration.

Case 2 is that the AMF notifies the UE of a candidate MCC list, i.e., a recommended MCC list, or a target MCC list accessible by the UE of the countries covered by a satellite with which the UE may attempt to register.

Alternatively, it is the case that the AMF notifies the UE of a target MCC list that may be used as targets in selecting a PLMN.

The recommended MCC list, target MCC list or candidate MCC list may be valid in the country where the UE is physically located. Specifically, when the UE is physically away from those in the recommended MCC list, target MCC list, or candidate MCC list and unable to use the MCCs, the recommended MCC list, target MCC list, or candidate MCC list may not be valid.

The AMF may send a list of neighboring candidate MCCs or target MCCs that may be accessed by the UE while sending the registration reject message to the UE.

For example, the UE makes access in a location of country A and the PLMN includes an MCC of the country A, but the PLMN may not be allowed in the country A for the reason of subscription of the UE or may not be the accessed for the reason of regulation or security of the country A. In this case, when access to an MCC of county B or country C, which is a neighboring country of the country A in the satellite coverage, is allowed, the AMF may send information about the MCC, i.e., an MCC list corresponding to the country B or country C, to the UE.

On receiving this, the UE selects a PLMN by limiting PLMN selections to MCCs in the target MCC list, recommended MCC list or candidate MCC list.

Case 3 is that the UE receives the registration reject message, and stores an MCC for which registration is failed in a forbidden MCC list.

Specifically, when the UE is not allowed for registration in the current location, i.e., when the UE receives the registration reject message, the UE may store the MCC of the PLMN in the forbidden MCC list.

In other words, when the UE attempts for registration but is not allowed for the registration, the UE may store the MCC of the PLMN in the forbidden MCC list.

Alternatively, in an embodiment, the AMF may send the UE a list of forbidden MCCs with which the UE is forbidden to register. In the case that the AMF sends the UE the list of forbidden MCCs with which the UE is forbidden to register, the UE may store the list of the MCCs in the forbidden MCC list. Alternatively, the UE stores the PLMN including the MCC as a forbidden PLMN and will not try to register with the PLMN.

There are following embodiments of a 5G MM cause or a cause transmitted in a parameter, information element, in the registration reject message.

The registration reject message may include a cause or 5GMM cause that explains why the registration is rejected.

When a 5GMM cause information element is used or a new cause information element is used, meaning and associated operation of the cause or 5GMM cause are as follows.

Case 1) 5GMM cause or cause #x: indicates that current location is not allowed, i.e., indicates that an MCC including the country A is not allowed in the current location.

Case 1-1) in an embodiment, the AMF may send the UE a 5GMM cause or cause number X to indicate that access of the UE is not allowed in the current location.

Case 1-2) alternatively, the 5GMM cause or the cause indicates the following details from the AMF to the UE Specifically, it may indicate that the UE is trying to access a PLMN where the UE is not allowed to operate in the current location.

Case 1-3) alternatively, the 5GMM cause or the cause indicates the following details from the AMF to the UE

It may also indicate that the UE is forbidden to select any PLMN belonging to the same home country or MCC as the selected PLMN in the current geographical location of the UE.

On receiving a registration reject message including the 5GMM cause or the cause, the UE registers with a PLMN including other MCC.

For example, in a case that the UE selects and registers with a PLMN including an MCC for country A in a location of the country A, when the UE receives a registration reject message including the 5GMM cause or the cause #x from the AMF in an embodiment, the UE tries registration for other MCC (e.g., a PLMN including the country B or a PLMN including the country C) than the country A in a subsequent registration request message later on.

Case 2) 5GMM cause or cause #y: indicates ‘current PLMN not allowed’.

In another embodiment, the AMF may send the UE a 5GMM cause or a cause indicating that access to the current PLMN is not allowed. On receiving registration reject including the 5GMM cause or the cause, the UE may store the PLMN as forbidden PLMN.

Case 3) 5GMM cause or cause #z: indicates that an MCC of the current region is not allowed.

The UE may receive, from the AMF, the 5GMM cause or the cause #z, i.e., the 5GMM cause or the cause indicating that registration of the UE with the MCC of the current region is not allowed.

For example, the registration reject including the 5GMM cause or the cause #z indicating that the UE is in a region covered by the country A but an MCC of the region is not allowed may be received. On receiving the registration reject message, the UE needs to register with a PLMN including an MCC indicating a country or region recommended by the AMF even when the UE is later in the region covered by the country A. In this case, when the satellite BS, i.e., the satellite NR, is present in a region covering the country A, country B and country C, and the satellite BS is shared by the countries A, B and C, the UE is guided to access a PLMN belonging to the country B or C according to regulation or UE subscription even when the UE is currently located close to a PLMN belonging to the country A.

Case 4) 5GMM cause or cause #xx: the AMF may send the UE the 5GMM cause or the cause indicating that service to the UE is not allowed in this region.

The UE may receive the registration reject message from the AMF, and when the 5GMM cause or the cause #XX is received, it indicates that the PLMN does not serve the UE in this location.

Hence, when receiving the 5GMM cause or the cause, the UE may find that the PLMN tried by the UE in the location does not serve the UE, and will not attempt registration for the PLMN or may delete the PLMN.

5GMM cause or cause #yy: it indicates that the UE is trying to register with a wrong country.

The 5GMM cause or the cause is used by the AMF to indicate to the UE that the UE is trying to register with other country than a country to which the UE needs to try PLMN selection. On receiving this, the UE does not attempt to register with the PLMN having the MCC.

5GMM cause or cause #zz: The AMF indicates to the UE through the 5GMM cause or the cause #zz that the UE needs to select a PLMN in other country.

The 5GMM cause or the cause is used to indicate to the UE to select a PLMN in other country. On receiving this, the UE needs to select and later attempt to register with a PLMN having with other MCC instead of an MCC of a PLMN having been selected and tried to register with.

As described above, when the UE receives registration reject from the AMF, the UE may operate as follows in subsequent operation 1425.

Case 1) the UE deletes the PLMN.

In the embodiment, when the UE receives registration reject including the 5GMM cause or the cause, the UE deletes the PLMN to which access has been tried from a PLMN list accessible by the UE. When the PLMN is not in the accessible PLMN list, the UE switches its state into the limited service state.

Case 2) the UE may store the PLMN and use it in the next registration request. For example, it may store the received PLMN or received MCC. Alternatively, it may store the received MCC list. Alternatively, it may store the received MCC list, and later use the MCC list to select a PLMN including the MCC list in the subsequent PLMN selection. Alternatively, a PLMN including the received MCC list may be stored as a candidate PLMN or a current location allowed PLMN.

This is a case that the AMF transmits, to the UE, information about a list of MCCs accessible in the region or the AMF provides information for the UE to make access based on the MCC of the current location.

Accordingly, in this case, when the UE receives an accessible MCC list, the UE may select a list of PLMNs including the MCC from the PLMN list, and try registration by sending a registration request to the reselected PLMN.

Case 3) the UE may replace the previous PLMN with corresponding PLMN information.

Case 4) the UE may additionally store the PLMN in addition to the previously received information.

Other parameter information elements included in the registration reject are as follows:
the UE accessible RAT type (or UE access allowable RAT type information element) is an information element, i.e., a, parameter, indicated by the AMF (network) to the UE. The UE accessible RAT type information is to notify the UE, by the AMF, of information about a RAT type allowed for the UE. The information notified by the AMF to the UE may include the following details: 1) an indication of a RAT type supported by the network, 2) a RAT type that may be served by the network for the UE among information of “RAT types (lists) that may be supported by the UE”, which is notified by the UE to the network through information about a capability of the UE, and 3) information about a supportable RAT type notified by the AMF to the UE based on subscription information of the UE.

Such information may be notified.
on receiving the information about a RAT type accessible by the UE, the UE may store the accessible RAT type information, and when transmitting a registration request message later on, use the information to perform registration. The UE may perform a function such as PLMN selection by selecting an accessible PLMN and RAT type for registration.
an indication indicating whether timer extension of the UE is possible is notified for the UE to set the timer as an extended timer for the satellite RAT.
RAT priority (extended priority) is to give priority to a UE accessible RAT based on subscription of the UE, rule/regulation of a region/country, regional property (sea or a region with no BS), etc., when the UE accessible RAT includes 5G NR, satellite NR, etc.
timer expansion value may be set by multiplying a default value of the timer by a timer extension value when the UE receives the timer extension value from the network in setting the timer for a message to be transmitted by the UE to the AMF. In an embodiment, in the case of LEO, MEO and LEO, the timer may be set by multiplying the default value of the timer by a timer extension enabled multiple.
timer extension fixed value is to set and indicate a value to set a timer according to a RAT type accessed by the UE in setting the timer for a message to be transmitted by the UE to the AMF. The timer extension fixed value may be transmitted according to a value defined in a regulation or specification depending on whether the RAT type of the satellite NR is LEO, MEO, GEO, or other RAT type.
the timer extension fixed value may be transmitted in an information element of an extended T3510 value, a T3510 value or a new timer T35xx value. The extended T3510 value may be transmitted as a value determined according to the satellite, when the RAT is the satellite, transmitted by using a GPRS timer, a GPRS timer 2, GPRS timer 3, etc., transmitted as a multiple of the GPRS timer, the GPRS timer 2, or the GPRS timer 3, or transmitted in the form of a satellite timer by defining the satellite timer. Alternatively, for the T3510, when a RAT type is a normal 5G RAN for a RAT on which the UE camps, i.e., a RAT known by the AMF as the RAT on which the UE camps, a T3510 default value may be transmitted, and when the RAT type is a satellite RAT, an extended T3510 value may be transmitted.

The registration reject message may include at least one other parameter, information element, included in Table 21. For example, an MCC in relation with the current location of the UE may be included in the registration reject message.

For example, when the UE accesses the AMF at a location in country A, the AMF may send an MCC of the country A in the registration reject message.

As shown in operation 1425, when the UE 101 receives a registration accept or registration reject message from the AMF 111, the UE 101 stops the T3510.

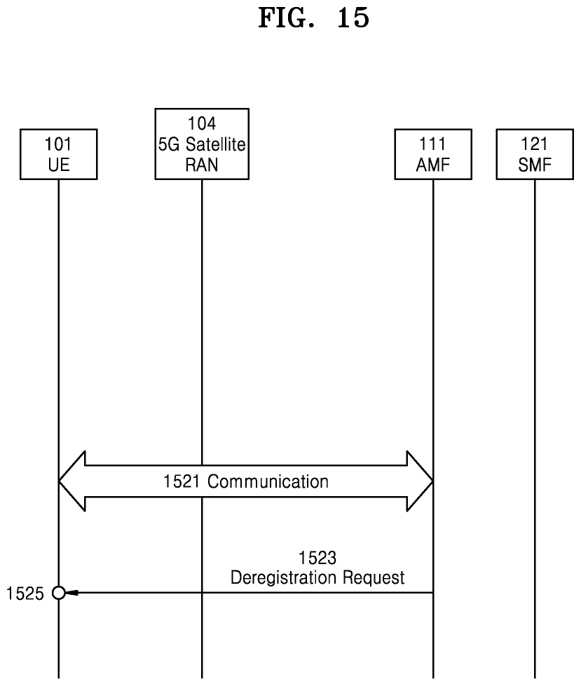

FIG. 15 is a sequence chart for describing a procedure for supporting communication in a system that supports fifth generation (5G) wireless communication and a satellite, according to an embodiment of the disclosure.

In FIG. 15, an operation of the AMF sending a deregistration request message to a UE is described.

In operation 1521, the UE communicates with a network entity such as the AMF.

Subsequent operation 1523 is a case that a deregistration request message is transmitted from the AMF to the UE. In other words, in operation 1523, the AMF may send the deregistration request message to the UE when deregistration of the UE is required. The deregistration request message is a message transmitted by the AMF to the UE to indicate that the UE has been deregistered. The deregistration request message may include one or two or more of IEs shown in Table 22, i.e., some of the IEs shown in Table 22 may be included in the deregistration request message.

TABLE 22
deregistration request message

| IEI | Information Element | Type/Reference | Presence | Format | Length |
|---|---|---|---|---|---|
| | Extended protocol discriminator | Extended protocol discriminator | M | V | 1 |
| | Security header type | Security header type | M | V | ½ |
| | Spare half octet | Spare half octet | M | V | ½ |
| | De-registration request message | Message type | M | V | 1 |
| | identity | | | | |
| | De-registration type | De-registration type | M | V | ½ |
| | Spare half octet | Spare half octet | M | V | ½ |
| | 5GMM cause | 5GMM cause | O | TV | 2 |
| | T3346 value | GPRS timer 2 | O | TLV | 3 |
| | Rejected NSSAI | Rejected NSSAI | O | TLV | 4-42 |
| | CAG information list | CAG information list | O | TLV-E | 3-n |
| | Extended rejected NSSAI | Extended rejected NSSAI | O | TLV | 4-74 |
| | Current location MCC list | | | | |
| | Candidate MCC list | | | | |
| | Forbidden MCC list | | | | |
| | UE accessible RAT type | | | | |
| | RAT priority | | | | |

There are following embodiments of an MCC list transmitted in a parameter, information element, in the deregistration request message.

In an embodiment, case 1 is that the AMF notifies the UE of an MCC of the current location so that the UE selects and access a PLMN having an MCC corresponding to the current location.

The AMF may send an MCC of the current location of the UE by sending the deregistration request message to the UE.

For example, when the UE makes access at a location in country A, an MCC of the country A may be sent. In other words, an MCC list corresponding to the country of the UE location may be sent.

On receiving the MCC list, the UE uses the MCC list to modify the MCC of the location of the UE. Specifically, on receiving the MCC list, the UE selects a PLMN including the received MCC and performs registration.

Case 2 is that the AMF notifies the UE of a candidate MCC list, i.e., a recommended MCC list, or a target MCC list accessible by the UE of the countries covered by a satellite with which the UE may attempt to register.

Alternatively it is the case that the AMF notifies the UE of a target MCC list that may be used as targets in selecting a PLMN.

The recommended MCC list, target MCC list or candidate MCC list may be valid in the country where the UE is physically located. Specifically, when the UE is physically away from those in the recommended MCC list, target MCC list, or candidate MCC list and unable to use the MCCs, the recommended MCC list, target MCC list, or candidate MCC list may not be valid.

The AMF may send a list of neighboring candidate MCCs or target MCCs that may be accessed by the UE while sending the deregistration request message to the UE.

For example, the UE makes access in a location of country A and the PLMN includes an MCC of the country A, but the PLMN may not be allowed in the country A for the reason of subscription of the UE or may not be the accessed for the reason of regulation or security of the country A. In this case, when access to an MCC of county B or country C, which is a neighboring country of the country A in the satellite coverage, is allowed, the AMF may send information about the MCC, i.e., an MCC list corresponding to the country B or country C, to the UE.

On receiving this, the UE selects a PLMN by limiting PLMN selections to MCCs in the target MCC list, recommended MCC list or candidate MCC list.

Case 3 is that the UE receives the deregistration request message, and stores an MCC for which registration is failed in a forbidden MCC list.

Specifically, when the UE is not allowed for registration at the current location, i.e., when the UE receives the deregistration request message, the UE may store the MCC of the PLMN in the forbidden MCC list.

In other words, when the UE receives the deregistration request message, the UE may store the MCC of the PLMN in the forbidden MCC list.

Alternatively, in an embodiment, the AMF may send the UE a list of forbidden MCCs to which registration of the UE is forbidden. In the case that the AMF sends the UE the list of forbidden MCCs with which the UE is forbidden to register, the UE may store the list of the MCCs in the forbidden MCC list. Alternatively, the UE stores the PLMN including the MCC as a forbidden PLMN and will not try to register with the PLMN.

There are following embodiments of a 5G MM cause and a cause transmitted in a parameter, information element, in the deregistration request message.

When a 5GMM cause information element is used or a new cause information element is used, meaning and associated operation of the cause or 5GMM cause are as follows.

The deregistration request message may include a 5GMM cause or a cause that explains why the deregistration is requested.

Case 1) 5GMM cause or cause #x: indicates that current location is not allowed, i.e., indicates that an MCC including the country A is not allowed in the current location.

Case 1-1) in an embodiment, the AMF may send the UE a 5GMM cause or cause number X to indicate that UE access is not allowed in the current location.

Case 1-2) alternatively, the 5GMM cause or the cause indicates the following details from the AMF to the UE Specifically, it may indicate that the UE is trying to access a PLMN where the UE is not allowed to operate in the current location.

Case 1-3) alternatively, the 5GMM cause or the cause indicates the following details from the AMF to the UE

It may also indicate that the UE is forbidden to select any PLMN belonging to the same home country or MCC as the selected PLMN in the current geographical location of the UE.

On receiving a deregistration request message including the 5GMM cause or the cause, the UE registers with a PLMN including other MCC.

For example, in a case that the UE performs registration by selecting a PLMN including an MCC for country A in a location of the country A, when the UE receives a registration reject message including the 5GMM cause or the cause #x from the AMF in an embodiment, the UE tries registration for other MCC (e.g., a PLMN including the country B or a PLMN including the country C) than the country A in a subsequent registration request message later on.

Case 2) 5GMM cause or cause #y: indicates ‘current PLMN not allowed’.

In another embodiment, the AMF may send the UE a 5GMM cause or a cause indicating that access to the current PLMN is not allowed. On receiving registration reject including the 5GMM cause or the cause, the UE may store the PLMN as forbidden PLMN.

Case 3) 5GMM cause or cause #z: indicates that an MCC of the current region is not allowed.

The UE may receive, from the AMF, the 5GMM cause or the cause #z, i.e., the 5GMM cause or the cause indicating that registration of the UE with the MCC of the current region is not allowed.

For example, the registration reject including the 5GMM cause or the cause #z indicating that the UE is in a region covered by the country A but an MCC of the region is not allowed may be received. On receiving the registration rejection, the UE needs to register with a PLMN including an MCC indicating a country or region recommended by the AMF even when the UE is later in the region covered by the country A. In this case, when the satellite BS, i.e., the satellite NR, is present in a region covering the country A, country B and country C, and the satellite BS is shared by the countries A, B and C, the UE is guided to access a PLMN belonging to the country B or C according to regulation or UE subscription even when the UE is currently located close to a PLMN belonging to the country A.

Case 4) 5GMM cause or cause #xx: the AMF may send the UE the 5GMM cause or the cause indicating that service to the UE is not allowed in this region.

The UE may receive the deregistration request message from the AMF, and when the 5GMM cause or the cause #XX is received, it indicates that the PLMN does not serve the UE in this location.

Hence, when receiving the 5GMM cause or the cause, the UE may find that the PLMN tried by the UE in the location does not serve the UE, and will not attempt registration for the PLMN or may delete the PLMN.

5GMM cause or cause #yy: it may indicate that the UE is trying to register with a wrong country.

The 5GMM cause or the cause is used by the AMF to indicate to the UE that the UE is trying to register with other country than a country to which the UE needs to try PLMN selection. On receiving this, the UE does not attempt to register with the PLMN having the MCC.

5GMM cause or cause #zz: The AMF indicates to the UE through the 5GMM cause or the cause #zz that the UE needs to select a PLMN in other country.

The 5GMM cause or the cause is used to indicate to the UE to select a PLMN in other country. On receiving this, the UE needs to select and later attempt to register with a PLMN having with other MCC instead of an MCC of a PLMN having been selected and tried to register with.

As described above, when the UE receives the deregistration request message from the AMF, the UE may operate as follows in subsequent operation 1525.

Case 1) the UE deletes the PLMN.

In the embodiment, when the UE receives a deregistration request message including the 5GMM cause or the cause, the UE deletes the PLMN to which access has been tried from a PLMN list accessible by the UE.

Case 2) the UE may store the PLMN and use it in the next registration request. For example, it may store the received PLMN or received MCC. Alternatively, it may store the received MCC list. Alternatively, it may store the received MCC list, and later use the MCC list to select a PLMN including the MCC list in the subsequent PLMN selection. Alternatively, a PLMN including the received MCC list may be stored as a candidate PLMN or a current location allowed PLMN.

This is a case that the AMF transmits, to the UE, information about a list of MCCs accessible in the region or the AMF provides information for the UE to make access based on the MCC of the current location.

Accordingly, in this case, when the UE receives an accessible MCC list, the UE may select a list of PLMNs including the MCC from the PLMN list, and try registration by sending a registration request to the reselected PLMN.

Case 3) the UE may replace the previous PLMN with corresponding PLMN information.

Case 4) the UE may additionally store the PLMN in addition to the previously received information.

Other parameter information elements included in the deregistration request message are as follows:
the UE accessible RAT type (or UE access allowable RAT type information element) is an information element, i.e., a parameter, indicated by the AMF (network) to the UE. The UE accessible RAT type information is to notify the UE, by the AMF, of information about a RAT type allowed for the UE. The information notified by the AMF to the UE may include the following details: 1) an indication of a RAT type supported by the network, 2) a RAT type that may be served by the network for the UE among information of “RAT types (lists) that may be supported by the UE”, which is notified by the UE to the network through information about a capability of the UE, and 3) information about a supportable RAT type notified by the AMF to the UE based on subscription information of the UE.

Such information may be notified.
on receiving the information about a RAT type accessible by the UE, the UE may store the accessible RAT type information, and when transmitting a registration request message later on, use the information to perform registration. The UE may perform a function such as PLMN selection by selecting an accessible PLMN and RAT type for registration.
RAT priority (extended priority) is to give priority to a UE accessible RAT based on subscription of the UE, rule/regulation of a region/country, regional property (sea or a region with no BS), etc., when the UE accessible RAT includes 5G NR, satellite NR, etc.

The deregistration request message may include at least one other parameter, information element, included in Table 22. For example, an MCC in relation with the current location of the UE may be included in the deregistration request message.

For example, when the UE accesses the AMF at a location in country A, the AMF may send an MCC of the country A in the deregistration request message.

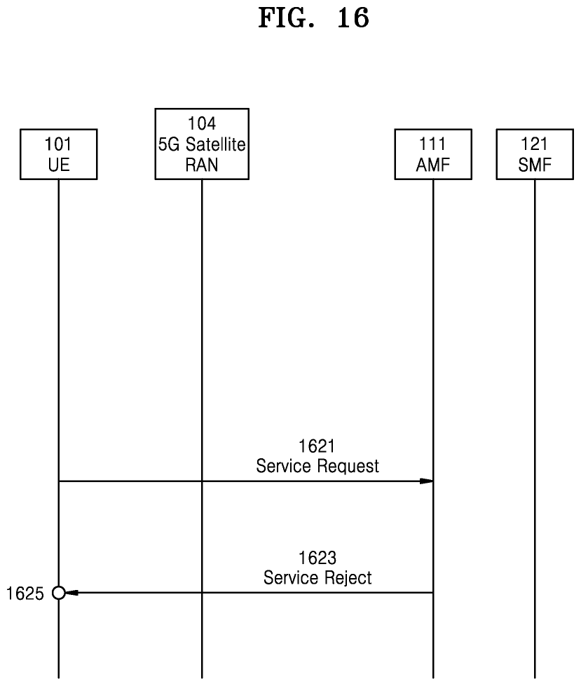

FIG. 16 is a sequence chart for describing a procedure for supporting communication in a system that supports 5G wireless communication and a satellite, according to an embodiment of the disclosure.

In FIG. 16, an operation of the AMF sending a service reject message to the UE is described.

In operation 1621, the UE transmits a service request message to the AMF.

Operation 1623 is a case that a service reject message is transmitted from the AMF to the UE. Specifically, in operation 1623, the AMF may transmit the service reject message to the UE to indicate that the service request requested by the UE is rejected. The service reject message may include one or two or more of IEs shown in Table 23, i.e., some of the IEs shown in Table 23 may be included in the service reject message.

TABLE 23
service reject message

| IEI | Information Elemont | Type/Reference | Presence | Format | Length |
|---|---|---|---|---|---|
| | Extended protocol discriminator | Extended protocol discriminator | M | V | 1 |
| | Security header type | Security header type | M | V | ½ |
| | Spare half octet | Spare half octet | M | V | ½ |
| | Service reject message identity | Message type | M | V | 1 |
| | 5GMM cause | 5GMM cause | M | V | 1 |
| 50 | PDU session status | PDU session status | O | TLV | 4-34 |
| 5F | T3345 value | GPRS timer 2 | O | TLV | 3 |
| 78 | EAP message | EAP message | O | TLV-E | 7-1503 |
| 6B | T3448 value | GPRS timer 2 | O | TLV | 3 |
| 75 | CAG information list | CAG information list | O | TLV-E | 3-n |
| | Current location MCC list | | | | |
| | Candidate MCC list | | | | |
| | Forbidden MCC list | | | | |
| | UE accessible RAT type | | | | |
| | RAT priority | | | | |

There are following embodiments of an MCC list transmitted in a parameter, information element, in the service reject message.

In an embodiment, case 1 is that the AMF notifies the UE of an MCC of the current location so that the UE selects and access a PLMN having an MCC corresponding to the current location.

The AMF may send an MCC of the current location of the UE by sending the service reject message to the UE.

For example, when the UE accesses the AMF at a location in country A, the AMF may send an MCC of the country A. Specifically, the AMF may send an MCC list corresponding to the country of the UE location.

On receiving the MCC list, the UE uses the MCC list to modify the MCC of the location of the UE. Specifically, on receiving the MCC list, the UE selects a PLMN including the received MCC and performs registration.

Case 2 is that the AMF notifies the UE of a candidate MCC list, i.e., a recommended MCC list, or a target MCC list accessible by the UE of the countries covered by a satellite with which the UE may attempt to register.

Alternatively, it is the case that the AMF notifies the UE of a target MCC list that may be used as targets in selecting a PLMN.

The recommended MCC list, target MCC list or candidate MCC list may be valid in the country where the UE is physically located. Specifically, when the UE is physically away from those in the recommended MCC list, target MCC list, or candidate MCC list and unable to use the MCCs, the recommended MCC list, target MCC list, or candidate MCC list may not be valid.

The AMF may send a list of neighboring candidate MCCs or target MCCs that may be accessed by the UE while sending the service reject message to the UE.

For example, the UE makes access in a location of country A and the PLMN includes an MCC of the country A, but the PLMN may not be allowed in the country A for the reason of subscription of the UE or may not be the accessed for the reason of regulation or security of the country A. In this case, when access to an MCC of county B or country C, which is a neighboring country of the country A in the satellite coverage, is allowed, the AMF may send information about the MCC, i.e., an MCC list corresponding to the country B or country C, to the UE.

On receiving this, the UE selects a PLMN by limiting PLMN selections to MCCs in the target MCC list, recommended MCC list or candidate MCC list.

Case 3 is that the UE receives the service reject message, and stores an MCC for which registration is failed in a forbidden MCC list.

Specifically, when the UE is not allowed for registration at the current location, i.e., when the UE receives the service reject message, the UE may store the MCC of the PLMN in the forbidden MCC list.

In other words, when the UE receives the service reject message, the UE may store the MCC of the PLMN in the forbidden MCC list.

Alternatively, in an embodiment, the AMF may send the UE a list of forbidden MCCs to which registration of the UE is forbidden. In the case that the AMF sends the UE the list of forbidden MCCs with which the UE is forbidden to register, the UE may store the list of the MCCs in the forbidden MCC list. Alternatively, the UE stores the PLMN including the MCC as a forbidden PLMN and will not try to register with the PLMN.

There are following embodiments of a 5GMM cause or a cause transmitted in a parameter, information element, in the service reject message.

When a 5GMM cause information element is used or a new cause information element is used, meaning and associated operation of the 5GMM cause or the cause are as follows.

The service reject message may include a 5GMM cause or a cause that explains why the service is rejected.

Case 1) 5GMM cause or cause #x: indicates that current location is not allowed, i.e., indicates that an MCC including the country A is not allowed in the current location.

Case 1-1) in an embodiment, the AMF may send the UE a 5GMM cause or cause number X to indicate that UE access is not allowed in the current location.

Case 1-2) alternatively, the 5GMM cause or the cause indicates the following details from the AMF to the UE Specifically, it may indicate that the UE is trying to access a PLMN where the UE is not allowed to operate in the current location.

Case 1-3) alternatively, the 5GMM cause or the cause indicates the following details from the AMF to the UE

It may also indicate that the UE is forbidden to select any PLMN belonging to the same home country or MCC as the selected PLMN in the current geographical location of the UE.

On receiving the service reject message including the 5GMM cause or the cause, the UE registers with a PLMN including other MCC.

For example, in a case that the UE performs registration by selecting a PLMN including an MCC for country A in a location of the country A, when the UE receives a registration reject message including the 5GMM cause or the cause #x from the AMF in an embodiment, the UE tries registration for other MCC (e.g., a PLMN including the country B or a PLMN including the country C) than the country A in a subsequent registration request message later on.

Case 2) 5GMM cause or cause #y: indicates ‘current PLMN not allowed’.

In another embodiment, the AMF may send the UE a 5GMM cause or a cause indicating that access to the current PLMN is not allowed. On receiving a registration reject message including the 5GMM cause or the cause, the UE may store the PLMN as forbidden PLMN.

Case 3) 5GMM cause or cause #z: indicates that an MCC of the current region is not allowed.

The UE may receive, from the AMF, the 5GMM cause or the cause #z, i.e., the 5GMM cause or the cause indicating that registration of the UE with the MCC of the current region is not allowed.

For example, the registration reject message including the 5GMM cause or the cause #z indicating that the UE is in a region covered by the country A but an MCC of the region is not allowed may be received. On receiving the registration reject message, the UE needs to register with a PLMN including an MCC indicating a country or region recommended by the AMF even when the UE is later in the region covered by the country A. In this case, when the satellite BS, i.e., the satellite NR, is present in a region covering the country A, country B and country C, and the satellite BS is shared by the countries A, B and C, the UE is guided to access a PLMN belonging to the country B or C according to regulation or UE subscription even when the UE is currently located close to a PLMN belonging to the country A.

Case 4) 5GMM cause or cause #xx: the AMF may send the UE the 5GMM cause or the cause indicating that service to the UE is not allowed in this region.

The UE may receive the service reject message from the AMF, and when the 5GMM cause or the cause #XX is received, it indicates that the PLMN does not serve the UE in this location.

Hence, when receiving the 5GMM cause or the cause, the UE may find that the PLMN tried by the UE in the location does not serve the UE, and will not attempt registration for the PLMN or may delete the PLMN.

5GMM cause or cause #yy: it may indicate that the UE is trying to register with a wrong country.

The 5GMM cause or the cause is used by the AMF to indicate to the UE that the UE is trying to register with other country than a country to which the UE needs to try PLMN selection. On receiving this, the UE does not attempt to register with the PLMN having the MCC.

5GMM cause or cause #zz: the AMF indicates to the UE through the 5GMM cause or the cause #zz that the UE needs to select a PLMN in other country.

The 5GMM cause or the cause is used to indicate to the UE to select a PLMN in other country. On receiving this, the UE needs to select and later attempt to register with a PLMN having with other MCC instead of an MCC of a PLMN having been selected and tried to register with.

As described above, when the UE receives a service reject message from the AMF, the UE may operate as follows in subsequent operation 1625.

Case 1) the UE deletes the PLMN.

In the embodiment, when the UE receives a service reject message including the 5GMM cause or the cause, the UE deletes the PLMN to which access has been tried from a PLMN list accessible by the UE.

Case 2) the UE may store the PLMN and use it in the next registration request or a service request.

For example, it may store the received PLMN or received MCC. Alternatively, it may store the received MCC list. Alternatively, it may store the received MCC list, and later use the MCC list to select a PLMN including the MCC list in the subsequent PLMN selection. Alternatively, a PLMN including the received MCC list may be stored as a candidate PLMN or a current location allowed PLMN.

This is a case that the AMF transmits, to the UE, information about a list of MCCs accessible in the region or the AMF provides information for the UE to make access based on the MCC of the current location.

Accordingly, in this case, when the UE receives an accessible MCC list, the UE may select a list of PLMNs including the MCC from the PLMN list, and try registration by sending a registration request to the reselected PLMN.

Case 3) the UE may replace the previous PLMN with corresponding PLMN information.

Case 4) the UE may additionally store the PLMN in addition to the previously received information.

Other parameter information elements included in the service reject message are as follows:
the UE accessible RAT type (or UE access allowable RAT type information element) is an information element, i.e., a parameter, indicated by the AMF (network) to the UE. The UE accessible RAT type information is to notify the UE, by the AMF, of information about a RAT type allowed for the UE. The information notified by the AMF to the UE may include the following details: 1) an indication of a RAT type supported by the network, 2) a RAT type that may be served by the network for the UE among information of “RAT types (lists) that may be supported by the UE”, which is notified by the UE to the network through information about a capability of the UE, and 3) information about a supportable RAT type notified by the AMF to the UE based on subscription information of the UE.

Such information may be notified.
on receiving the information about a RAT type accessible by the UE, the UE may store the accessible RAT type information, and when transmitting a registration request message later on, use the information to perform registration. The UE may perform a function such as PLMN selection by selecting an accessible PLMN and RAT type for registration.
RAT priority (extended priority) is to give priority to a UE accessible RAT based on subscription of the UE, rule/regulation of a region/country, regional property (sea or a region with no BS), etc., when the UE accessible RAT includes 5G NR, satellite NR, etc.

The service reject message may include at least one other parameter, information element, included in Table 23. For example, an MCC in relation with the current location of the UE may be included in the service reject message.

For example, when the UE accesses the AMF at a location in country A, the AMF may send an MCC of the country A in the service reject message.

In the embodiments of the disclosure, a component is represented in a singular or plural form. It should be understood, however, that the singular or plural representations are selected appropriately according to the situations presented for convenience of explanation, and the disclosure is not limited to the singular or plural form of the component. Further, the component expressed in the plural form may also imply the singular form, and vice versa.

Several embodiments of the disclosure have thus been described, but it will be understood that various modifications can be made without departing the scope of the disclosure. Thus, it will be apparent to those ordinary skilled in the art that the disclosure is not limited to the embodiments described, but can encompass not only the appended claims but the equivalents.

1. A user equipment (UE) for performing communication in a wireless communication system, the UE comprising:
a transceiver; and
a processor connected to the transceiver and configured to:
transmit, by the UE, a registration request message for accessing a public land mobile network (PLMN) to an access and mobility management function (AMF) through a satellite radio access network (RAN),
receive, by the UE, a registration reject message from the AMF through the satellite RAN in response to the transmitted registration request message, and
store the PLMN in a PLMN list not allowed in a current location of the UE based on a cause value included in the received registration reject message.

2. The UE of claim 1, wherein access is not attempted with respect to at least one PLMN stored in the PLMN list not allowed in the current location of the UE.

3. The UE of claim 1, wherein the registration reject message comprises information about configuration of the extended timer.

4. The UE of claim 1, wherein the registration reject message comprises information indicating a country where the UE is currently located.

5. An access and mobility management function (AMF) for performing communication in a wireless communication system, the AMF comprising:
a transceiver; and
a processor connected to the transceiver and configured to:
receive, from a user equipment (UE), a registration request message for accessing a public land mobile network (PLMN) through a satellite radio access network (RAN),
transmit a registration reject message to the UE through the satellite RAN in response to the transmitted registration request message when the PLMN is not allowed in a current location of the UE, wherein the registration reject message includes a cause value indicating that the PLMN is not allowed in the current location of the UE, and
store the PLMN in a PLMN list not allowed in the current location of the UE based on the cause value in the registration reject message.

6. The AMF of claim 5, wherein access of the UE is not attempted with respect to at least one PLMN stored in the PLMN list not allowed in the current location of the UE.

7. The AMF of claim 5, wherein the registration reject message comprises information about configuration of the extended timer.

8. The AMF of claim 5, wherein the registration reject message comprises information indicating a country where the UE is currently located.

9. A method by which a user equipment (UE) performs communication in a wireless communication system, the method comprising:
transmitting, by the UE, a registration request message for accessing a public land mobile network (PLMN) to an access and mobility management function (AMF) through a satellite radio access network (RAN);
receiving, by the UE, a registration reject message from the AMF through the satellite RAN in response to the transmitted registration request message; and
storing the PLMN in a PLMN list not allowed in a current location of the UE based on a cause value included in the received registration reject message.

10. The method of claim 9, wherein access is not attempted with respect to at least one PLMN stored in the PLMN list not allowed in the current location of the UE.

11. The method of claim 9, wherein the registration reject message comprises information about configuration of the extended timer.

12. The method of claim 9, wherein the registration reject message comprises information indicating a country where the UE is currently located.

13. A method by which an access and mobility management function (AMF) performs communication in a wireless communication system, the method comprising:
receiving, from a user equipment (UE), a registration request message for accessing a public land mobile network (PLMN) through a satellite radio access network (RAN); and
transmitting a registration reject message to the UE through the satellite RAN in response to the transmitted registration request message when the PLMN is not allowed in a current location of the UE,
wherein the registration reject message comprises a cause value indicating that the PLMN is not allowed in the current location of the UE, and
wherein the PLMN is stored in a PLMN list not allowed in the current location of the UE based on the cause value in the registration reject message.

14. The method of claim 13, wherein the registration reject message comprises information about configuration of the extended timer.

15. The method of claim 13, wherein the registration reject message comprises information indicating a country where the UE is currently located.
